(19) United States
(12) Patent Application Publication
(10) Pub. No.: US 2026/0051990 A1
(43) Pub. Date: Feb. 19, 2026

(54) SRS TRANSMISSION METHOD AND TERMINAL DEVICE

(71) Applicant: Guangdong Oppo Mobile Telecommunications Corp., Ltd., Dongguan (CN)

(72) Inventors: Wenhong CHEN, Dongguan (CN); Yingpei Huang, Dongguan (CN)

(73) Assignee: Guangdong Oppo Mobile Telecommunications Corp., Ltd., Dongguan (CN)

(21) Appl. No.: 19/367,964

(22) Filed: Oct. 24, 2025

Related U.S. Application Data
(63) Continuation of application No. PCT/CN2023/105930, filed on Jul. 5, 2023.

(51) Int. Cl. H04L 5/00; H04W 24/08; H04W 72/0446

(52) U.S. Cl. CPC H04L 5/0048; H04W 24/08; H04W 72/0446

(57) ABSTRACT

An SRS transmission method and a terminal device are provided. The method includes an operation as follows. A terminal device sends SRSs on multiple SRS resources or multiple SRS resource sets. The SRSs on the multiple SRS resources or the multiple SRS resource sets adopt the same transmission mode and the same transmission resource, and have phase consistency.

### CROSS-REFERENCE TO RELATED APPLICATION

This is a continuation application of International Patent Application No. PCT/CN2023/105930, filed on Jul. 5, 2023, the disclosure of which is hereby incorporated by reference in its entirety.

### BACKGROUND

A network device can perform real-time channel measurements based on a sounding reference signal (SRS) sent by a terminal device, in order to determine the precoding matrix used for uplink transmission and indicate the precoding matrix to the terminal device through a codebook, or determine the precoding matrix used for downlink transmission based on channel reciprocity. Since the channel is variable, the network device should configure the terminal device for performing frequent SRS transmission, so that the precoding matrix can adapt to the current channel as much as possible, which will result in a large amount of SRS resource overhead. Moreover, the precoding matrix is obtained based on the current channel measurement, while the scheduled uplink or downlink transmission usually occurs after several slots, resulting in a certain lag and inaccuracy of the precoding matrix relative to the scheduled uplink or downlink transmission.

On the other hand, the terminal device performs time domain channel property (TDCP) measurement according to the tracking reference signal (TRS) sent by the network device, and feedback Doppler related time domain channel properties to the network device which are used by the network device for configuring uplink and downlink transmission. However, this mode causes relatively high measurement complexity for the terminal device, as well as significant TRS resource overhead and feedback signaling overhead.

### SUMMARY

The embodiments of the disclosure relate to the technical field of mobile communication, and in particular to a sounding reference signal (SRS) transmission method and device and a terminal device.

A first aspect of the embodiments of the disclosure provides an SRS transmission method, which includes the following operation.

A terminal device sends SRSs on multiple SRS resources or multiple SRS resource sets. The SRSs on the multiple SRS resources or the multiple SRS resource sets adopt a same transmission mode and a same transmission resource, and have phase consistency.

A second aspect of the embodiments of the disclosure provides an SRS transmission method, which includes the following operation.

A network device receives SRSs sent by a terminal device on multiple SRS resources or multiple SRS resource sets. The SRSs on the multiple SRS resources or the multiple SRS resource sets adopt a same transmission mode and a same transmission resource, and have phase consistency.

A third aspect of the embodiments of the disclosure provides a terminal device, which includes a processor, a transceiver and a memory. The memory is configured to store a computer program, and the processor is configured to invoke and run the computer program stored in the memory to control the transceiver to send SRSs on multiple SRS resources or multiple SRS resource sets. The SRSs on the multiple SRS resources or the multiple SRS resource sets adopt a same transmission mode and a same transmission resource, and have phase consistency.

### BRIEF DESCRIPTION OF THE DRAWINGS

The accompanying drawings illustrated herein are used to provide a further understanding of and constitute a part of the disclosure, and the illustrative embodiments of the disclosure and the description thereof are used to explain the disclosure and do not constitute an undue limitation of the disclosure. In the drawings below.

FIG. 1 is a schematic diagram of an application scenario of an embodiment of the disclosure.

FIG. 2 is a schematic diagram of DCI triggering an aperiodic SRS.

FIG. 3 is a schematic diagram of time-frequency resources of SRS resources.

FIG. 4 is a first flow diagram of an SRS transmission method provided by an embodiment of the disclosure.

FIG. 5 is a second flow diagram of an SRS transmission method provided by an embodiment of the disclosure.

FIG. 6 is a first schematic diagram of positions of SRS resources in the time domain provided by an embodiment of the disclosure.

FIG. 7 is a second schematic diagram of positions of SRS resources in the time domain provided by an embodiment of the disclosure.

FIG. 8 is a first schematic diagram of positions of SRS resource sets in the time domain provided by an embodiment of the disclosure.

FIG. 9 is a first schematic diagram of SRS resources within time windows provided by an embodiment of the disclosure.

FIG. 10 is a second schematic diagram of SRS resources within time windows provided by an embodiment of the disclosure.

FIG. 11 is a schematic diagram of uplink channel prediction based on SRSs on SRS resources provided by an embodiment of the disclosure.

FIG. 12 is a third flow diagram of an SRS transmission method provided by an embodiment of the disclosure.

FIG. 13 is a second schematic diagram of positions of SRS resource sets in the time domain provided by an embodiment of the disclosure.

FIG. 14 is a first schematic diagram of SRS resource sets within time windows provided by an embodiment of the disclosure.

FIG. 15 is a second schematic diagram of SRS resource sets within time windows provided by an embodiment of the disclosure.

FIG. 16 is a schematic diagram of downlink channel prediction based on SRSs on SRS resource sets provided by an embodiment of the disclosure.

FIG. 17 is a fourth flow diagram of an SRS transmission method provided by an embodiment of the disclosure.

FIG. 18 is a fifth flow diagram of an SRS transmission method provided by an embodiment of the disclosure.

FIG. 19 is a sixth flow diagram of an SRS transmission method provided by an embodiment of the disclosure.

FIG. 20 is a seventh flow diagram of an SRS transmission method provided by an embodiment of the disclosure.

FIG. 21 is a first schematic structural composition diagram of an SRS transmission device provided by an embodiment of the disclosure.

FIG. 22 is a second schematic structural composition diagram of an SRS transmission device provided by an embodiment of the disclosure.

FIG. 23 is a schematic structural diagram of a communication device provided by an embodiment of the disclosure.

FIG. 24 is a schematic structural diagram of a chip of an embodiment of the disclosure.

FIG. 25 is a schematic block diagram of a communication system provided by an embodiment of the disclosure.

### DETAILED DESCRIPTION

The technical solution of embodiments of the disclosure will be described below in conjunction with the accompanying drawings of embodiments of the disclosure. It is apparent that the described embodiments are some rather than all embodiments of the disclosure. All other embodiments obtained by those ordinarily skilled in the art based on embodiments of the disclosure without paying any inventive effort shall fall within the scope of protection of the disclosure

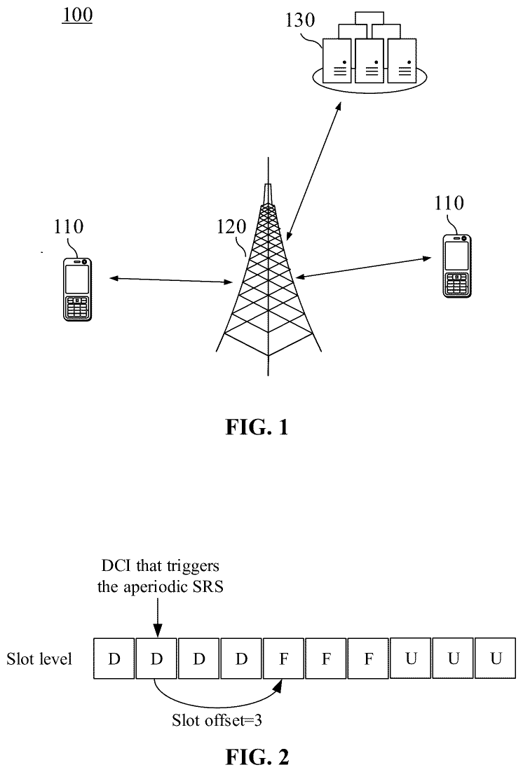

FIG. 1 is a schematic diagram of an application scenario of an embodiment of the disclosure.

As shown in FIG. 1, a communication system 100 may include a terminal device 110 and a network device 120. The network device 120 may communicate with the terminal device 110 through an air interface. Multi-service transmission is supported between the terminal device 110 and the network device 120.

It should be understood that embodiments of the disclosure are only illustrated by taking the communication system 100 as an example, but are not limited thereto. That is, the technical solution of embodiments of the disclosure may be applied to various communication systems, such as a long term evolution (LTE) system, an LTE time division duplex (TDD), a universal mobile telecommunication system (UMTS), an Internet of Things (IOT) system, a narrow band Internet of Things (NB-IOT) system, an enhanced machine-type communications (eMTC) system, a 5G communication system (also referred to as a new radio (NR) communication system), or a future communication system, etc.

In the communication system 100 shown in FIG. 1, the network device 120 may be an access network device that communicates with the terminal device 110. The access network device may provide communication coverage for a particular geographic area and may communicate with a terminal device 110 (such as user equipment (UE)) located within the coverage area.

The network device 120 may be an evolutional base station (evolutional node B, eNB or eNodeB) in the LTE system, or a next generation radio access network (NG RAN) device, or a base station (gNB) in an NR system, or a wireless controller in a cloud radio access network (CRAN), or the network device 120 may be a relay station, an access point, a vehicle-mounted device, a wearable device, a hub, a switch, a bridge, a router, or a network device in a future evolved public land mobile network (PLMN), etc.

The terminal device 110 may be any terminal device including but not limited to a terminal device in wired or wireless connection with the network device 120 or other terminal devices.

For example, the terminal device 110 may refer to an access terminal, a UE, a user unit, a user station, a mobile station, a remote station, a remote terminal, a mobile device, a user terminal, a terminal, a wireless communication device, a user agent, or a user device. The access terminal may be a cellular telephone, a cordless telephone, a session initiation protocol (SIP) telephone, an IoT device, a satellite handheld terminal, a wireless local loop (WLL) station, a personal digital assistant (PDA), a handheld device having wireless communication function, a computing device or other processing devices connected to a wireless modem, a vehicle-mounted device, a wearable device, a terminal device in the 5G network or a terminal device in the future evolved network, and the like.

The terminal device 110 may be used for device to device (D2D) communication.

The wireless communication system 100 may also include a core network device 130 that communicates with a base station, and the core network device 130 may be a 5G core (5GC) device with, for example, an access and mobility management function (AMF), an authentication server function (AUSF), a user plane function (UPF), a session management function (SMF). Optionally, the core network device 130 may also be an evolved packet core (EPC) device of the LTE network, for example, a device with session management function+core packet gateway (SMF+PGW-C). It should be understood that SMF+PGW-C may simultaneously achieve the functions that SMF and PGW-C can achieve. In the process of network evolution, the above core network device may also be referred to as other names, or a new network entity may be formed by dividing the functions of the core network, which is not limited by embodiments of the disclosure.

The functional units in the communication system 100 may also establish a connection through a next generation (NG) interface to realize communication.

For example, the terminal device establishes an air interface connection with the access network device through the NR interface for transmitting user plane data and control plane signaling. The terminal device may establish a control plane signaling connection with the AMF through an NG interface 1 (N1 for short). The access network device such as a next generation radio access base station (gNB) may establish a user plane data connection with UPF through an NG interface 3 (N3 for short). The access network device may establish a control plane signaling connection with AMF through an NG interface 2 (N2 for short). The UPF may establish a control plane signaling connection with SMF through an NG interface 4 (N4 for short). The UPF may interact user plane data with data network through an NG interface 6 (N6 for short). The AMF may establish a control plane signaling connection with the SMF through an NG interface 11 (N11 for short). The SMF may establish a control plane signaling connection with the PCF through an NG Interface 7 (N7 for short).

FIG. 1 exemplarily illustrates a base station, a core network device and two terminal devices. In an example, the wireless communication system 100 may include multiple base station devices, and the coverage area of each base station may include other numbers of terminal devices, which is not limited by embodiments of the disclosure.

It is to be noted that FIG. 1 merely illustrates a system to which the disclosure is applied in an exemplary way. In practical, the method illustrated in embodiments of the disclosure may also be applied to other systems. In addition, the terms “system” and “network” herein are often used interchangeably. The term “and/or” herein merely describes a relationship between associated objects, representing that three relationships may exist. For example, A and/or B may represent following three cases: independent existence of A, existence of both A and B, and independent existence of B. In addition, the character “/” herein generally represents that the contextual objects are in an “or” relationship. It is also to be understood that “indicate” in embodiments of the disclosure may be a direct indication or an indirect indication, or may refer to that there is an association relationship. By way of example, “A indicates B” may refer to that A directly indicates B, for example, B may be acquired through A. “A indicates B” may also refer to that A indirectly indicates B, for example, A indicates C and B may be acquired through C. “A indicates B” may also refer to that there is an association relationship between A and B. It is also to be understood that “correspond” referred in embodiments of the disclosure may mean that there is a direct correspondence or an indirect correspondence between two objects, or may mean that there is an association relationship between the two objects, or may mean a relationship that one object indicates or is indicated by another object or a relationship that one object configures or is configured by another object. It is also to be understood that “predefine” or “predefined rule” referred in embodiments of the disclosure may be realized by pre-storing corresponding codes or tables in a device (for example, a terminal device and a network device) or in other ways that can be used to indicate relevant information. The specific implementation is not limited in the disclosure. For example, “predefined” may refer to being defined in a protocol. It is also to be understood that, in embodiments of the disclosure, the “protocol” may refer to standard protocols in the field of communications, for example, the LTE protocol, the NR protocol or relevant protocols applied in future communication systems, which is not limited in embodiments of the disclosure.

For facilitating understanding the technical solution of embodiments of the disclosure, the relevant technologies of embodiments of the disclosure are described hereinafter. The relevant technologies may be, as optional solutions, arbitrarily combined with the technical solutions of embodiments of the disclosure, and the combination shall fall within the scope of protection of embodiments of the disclosure.

### Usage of SRS

SRS is an important reference signal in the NR system, and is widely used in various functions of the NR system, such as the following functions.

The SRS is used for obtaining downlink channel state information.

The SRS is used for uplink beam management.

The SRS is used for positioning function.

The SRS is used for codebook-based uplink transmission (including frequency domain scheduling and rank/precoding matrix indication, as well as determining modulation and coding modes).

The SRS is used for non-codebook-based uplink transmission (including frequency domain scheduling and rank/precoding matrix indication, as well as determining modulation and coding modes).

The network device may configure one or more SRS resource sets for the terminal device, and each SRS resource set may contain one or more SRS resources. The network device may configure a function for each SRS resource set through high-level signaling (specifically through usage parameters) to indicate the usage of the SRS resource set, so that terminal device can adopt the transmission mode and the transmission resource corresponding to the usage specified in the protocol. The current usage supported by the protocol may be configured to be: codeBook (used for codebook-based uplink transmission), nonCodebook (used for non-codebook-based uplink transmission), antennaSwitching (used for obtaining downlink channel state information), and beamManagement (used for uplink beam management).

### Periodicity of SRS

According to the periodicity of SRS transmission, the SRS can be classified into periodic SRS, semi-persistent SRS, and aperiodic SRS which are described in detail as follows.

1. Periodic SRS and semi-persistent SRS

The periodic SRS refers to an SRS that is transmitted periodically, and the period and slot offset of the SRS are configured by radio resource control (RRC) signaling. Once the terminal device receives the corresponding RRC configuration, the terminal device sends the SRS at a certain period until the RRC configuration expires. The spatial related information (used for determining the sending beam) of the periodic SRS is also configured by the RRC signaling, and may indicate a channel state information-reference signal (CSI-RS), a synchronization signal and PBCH block (SSB), or a reference SRS. The terminal device determines a transmitting beam of the target SRS resource according to the receiving beam of CSI-RS/SSB indicated by the spatial related information, or determines the transmitting beam of the target SRS resource according to the transmitting beam of the reference SRS resource. It should be noted that an SRS resource where the periodic SRS is located may be referred to as a periodic SRS resource.

The semi-persistent SRS is also an SRS that is transmitted periodically, and the period and slot offset of the SRS are configured by the RRC signaling, but the activation and deactivation signaling of the SRS is carried through a media access control control element (MAC CE). After receiving the activation signaling, the terminal device begins to transmit the SRS periodically until the terminal device receives the deactivation signaling. The spatial related information (used for determining the transmitting beam) of the semi-persistent SRS is carried also by the MAC CE for activating the SRS. The spatial related information may indicate a CSI-RS, an SSB, or a reference SRS. The terminal device determines the transmitting beam of the target SRS resource according to the receiving beam of the CSI-RS/SSB indicated by the spatial related information, or determines the transmitting beam of the target SRS resource according to the transmitting beam of the reference SRS resource. It should be noted that an SRS resource where the semi-persistent SRS is located may be referred to as a semi-persistent SRS resource.

After receiving the period and slot offset configured by the RRC signaling, the terminal device may determine the slot that can be used for transmitting SRSs according to the following formula:

$$( {N}_{slot}^{f r a m e , μ} {n}_{f} + {n}_{s , f}^{μ} - {T}_{offset} ) m o d {T}_{SRS} = 0$$

Here,

$${N}_{slot}^{frame , μ}$$

represents the number of slots contained in a wireless frame, T_{SRS} is the period configured by the RRC signaling, T_{offset} is the slot offset configured by the RRC signaling, and n_{f} and

$${n}_{s , f}^{μ}$$

are the wireless frame number and slot number used for transmitting SRSs, respectively.

### 2. Aperiodic SRS

The aperiodic SRS refers to an SRS that is transmitted aperiodically, and the network device may trigger the aperiodic SRS transmission of the terminal device through the trigger signaling. The trigger signaling used for triggering the aperiodic SRS transmission may be carried through downlink control information (DCI). On the one hand, the trigger signaling (which may be referred to as SRS trigger signaling) used for triggering the aperiodic SRS transmission may be carried through uplink DCI or downlink DCI. The uplink DCI refers to the DCI used for scheduling uplink transmission, and the downlink DCI refers to the DCI used for scheduling downlink transmission. The uplink transmission may be physical uplink shared channel (PUSCH) transmission, and the downlink transmission may be physical downlink shared channel (PDSCH) transmission. On the other hand, the trigger signaling used for triggering the aperiodic SRS transmission may be carried through DCI used for scheduling PUSCH/PDSCH in the UE dedicated search space, or may be carried through DCI format 2_3 in the common search space. Herein, DCI format 2_3 may not only be used for triggering the aperiodic SRS transmission, but also simultaneously configuring the transmit power control (TPC) command for the SRS on a group of terminal devices or a group of carriers. The trigger signaling of the SRS may be implemented through the SRS request field in DCI. Exemplarily, Table 1 below shows the meanings of different values of the SRS request field. There are correspondences between the SRS resource sets and the values of the high-level parameter aperiodicSRS-Resource Trigger. Therefore, an SRS resource set may be determined according to the values of the high-level parameter aperiodicSRS-Resource Trigger.

TABLE 1
SRS trigger signaling

| | DCI format 0_1, 1_0, and 2_3 trigger the aperiodic |
|---|---|
| | SRS resource set, and the high-level parameter srs- |
| Values of SRS | TPC-PDCCH-Group configured by DCI format 2_3 |
| request field | is set to be ‘typeB’ |
| 00 | No aperiodic SRS resource set is triggered |
| 01 | The SRS resource set configured by “the high-level |
| | parameter aperiodicSRS-ResourceTrigger is set to |
| | 1” is triggered |
| 10 | The SRS resource set configured by “the high-level |
| | parameter aperiodicSRS-ResourceTrigger is set to |
| | 2” is triggered |
| 11 | The SRS resource set configured by “the high-level |
| | parameter aperiodicSRS-ResourceTrigger is set to |
| | 3” is triggered |

After receiving the trigger signaling of the aperiodic SRS (such as DCI), the terminal device performs SRS transmission on an SRS resource set indicated by the trigger signaling. Herein, the slot offset between the trigger signaling and the SRS transmission is configured by high-level signaling (such as the RRC signaling). The network device indicates configuration parameters of each SRS resource set to the terminal device through high-level signaling, including time-frequency resources, sequence parameters, and power control parameters, etc. In addition, for each SRS resource in the triggered SRS resource set, the terminal device may also determine the transmitting beam used for transmitting SRSs on a SRS resource based on the spatial related information of the SRS resource. The spatial related information is configured to each SRS resource through the RRC signaling.

Herein, regarding slot offset, as shown in FIG. 2, if the terminal device receives DCI that triggers the aperiodic SRS on slot n, the terminal device will send the SRS on the SRS resources in the SRS resource set on slot

$$⌊ n \cdot \frac{{2}^{{μ}_{SRS}}}{{2}^{{μ}_{PDCCH}}} ⌋ + k .$$

Herein, k is indicated by the parameter slotOffset configured for the SRS resource set, and μ_{SRS} and μ_{PDCCH} are the subcarrier spacing configuration of the SRS triggered by the trigger command and the subcarrier spacing configuration of the physical downlink control channel (PDCCH) where the trigger command is located, respectively. In the example shown in FIG. 2, slotOffset=3.
Multi-symbol SRS transmission

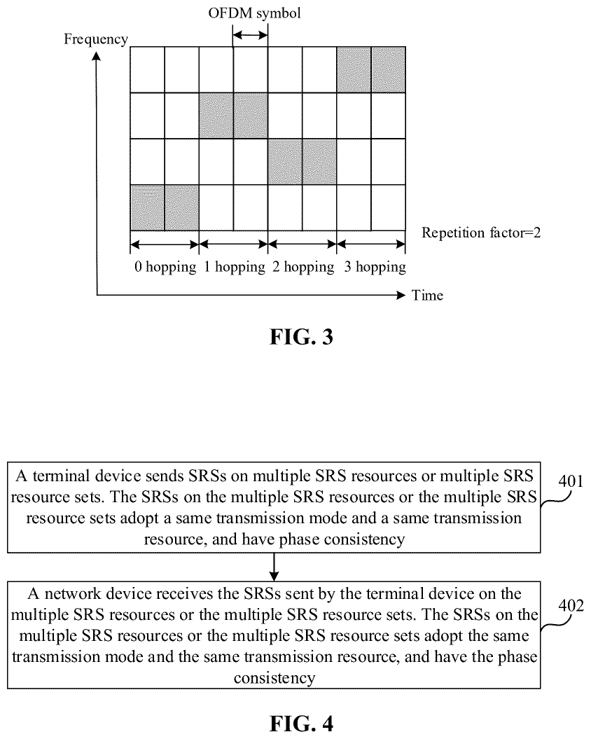

In the NR system, an SRS resource may be transmitted on multiple consecutive orthogonal frequency division multiplexing (OFDM) symbols, for example, on the last N (N≥1) OFDM symbols in a slot. The terminal device can transmit all SRS antenna ports on each OFDM symbol, but the physical resources used on different OFDM symbols may be different. SRSs on different OFDM symbols may have different transmission modes, that is, multiple consecutive OFDM symbols may have different usages. For example, when the network side requires a wideband detection signal, the terminal device may be configured to perform frequency domain hopping on multiple OFDM symbols. If the current SRS is used for selecting a receiving beam (only for high frequencies), the terminal device may use the same transmitting beam to transmit the SRS on multiple OFDM symbols, and the network side may use different receiving beams to receive on different OFDM symbols, thereby determining the best receiving beam. If the coverage of the current SRS signal is limited, the same SRS is repeatedly transmitted on multiple OFDM symbols to improve the coverage of SRS. The network device may configure one or more SRSs for different usages on multiple OFDM symbols occupied by one SRS resource. For example, one SRS resource occupies 8 OFDM symbols, where every two OFDM symbols performs repeat transmission for a total of 4 sets of frequency domain hopping (where the frequency domain resources occupied by the repeat transmission are the same), as shown in FIG. 3.

In the related art, the network device may perform real-time channel measurement according to an SRS sent by the terminal device, in order to determine the precoding matrix used for uplink transmission and indicate the precoding matrix to the terminal device through a codebook, or determine the precoding matrix used for downlink transmission based on channel reciprocity. Since the channel is variable, the network device should configure the terminal device for performing frequent SRS transmission, so that the precoding matrix can adapt to the current channel as much as possible, which will result in a large amount of SRS resource overhead. Moreover, the precoding matrix is obtained based on the current channel measurement, while the scheduled uplink or downlink transmission usually occurs after several slots, resulting in a certain lag and inaccuracy of the precoding matrix relative to the scheduled uplink or downlink transmission. In another aspect, the protocol introduces TRS-based TDCP measurements. The terminal device may perform TDCP measurement according to the TRS sent by the network device, and feedback Doppler related time domain channel properties (such as time domain channel related matrix, time domain Doppler parameters, etc.) which are used by the network device for configuring uplink and downlink transmission (such as reference signal configuration or CSI feedback configuration) to adapt to the speed of channel changes. However, this mode causes relatively high measurement complexity for the terminal device, as well as significant TRS resource overhead and CSI feedback signaling overhead.

Therefore, a technical solution for embodiments of the disclosure is proposed. In order to facilitate understanding of the technical solution of embodiments of the disclosure, the technical solution of the disclosure is described in detail below by way of specific embodiments. The above related art may be, as an optional solution, arbitrarily combined with the technical solution of embodiments of the disclosure, and all of them belong to the protection scope of embodiments of the disclosure. The embodiments of the disclosure include at least some of the following.

It should be noted that the “symbol” described in embodiments of the disclosure may be an OFDM symbol.

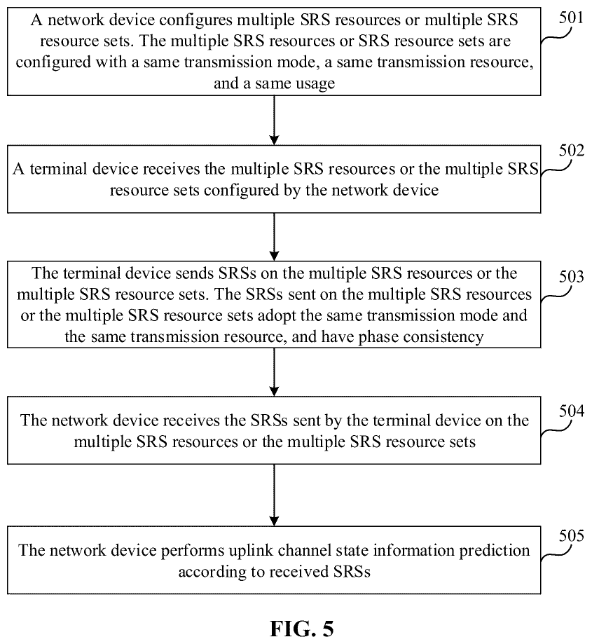

FIG. 4 is a schematic flowchart of an SRS transmission method provided by an embodiment of the disclosure. As shown in FIG. 4, the method includes one or more of the following operations.

At 401, a terminal device sends SRSs on multiple SRS resources or multiple SRS resource sets. The SRSs on the multiple SRS resources or the multiple SRS resource sets have a same transmission mode and a same transmission resource, and have phase consistency.

At 402, a network device receives the SRSs sent by the terminal device on the multiple SRS resources or the multiple SRS resource sets. The SRSs on the multiple SRS resources or the multiple SRS resource sets adopt the same transmission mode and the same transmission resource, and have the phase consistency.

In some implementations, the terminal device may send SRSs on multiple SRS resources. The SRSs on the multiple SRS resources adopt the same transmission mode and the same transmission resource, and have the phase consistency. In other implementations, the terminal device may send SRSs on multiple SRS resource sets. The SRSs on the multiple SRS resource sets adopt the same transmission mode and the same transmission resource, and have the phase consistency.

It should be noted that the terminal device may also send SRSs on one SRS resource set, and the SRS resource set includes multiple SRS resources. Therefore, this case may also be understood as, the terminal device sends SRSs on multiple SRS resources, and the SRSs on the multiple SRS resources adopt the same transmission mode and the same transmission resource, and have the phase consistency.

Before sending the SRSs on the multiple SRS resources or the multiple SRS resource sets, the terminal device obtains configuration information of the multiple SRS resources or the multiple SRS resource sets.

In some implementations, the network device sends first configuration information to the terminal device. Accordingly, the terminal device receives the first configuration information sent by the network device. The first configuration information is used for configuring the multiple SRS resources or the multiple SRS resource sets, or the first configuration information includes configuration information of the multiple SRS resources or the multiple SRS resource sets. The multiple SRS resources or the multiple SRS resource sets are configured with the same transmission mode, the same transmission resource, and the same usage.

It should be noted that the transmission mode, the transmission resource, and the usage of an SRS resource may also be understood as the transmission mode, the transmission resource, and the usage of SRSs transmitted on the SRS resource. The transmission mode, the transmission resource, and the usage of an SRS resource set may also be understood as the transmission mode, the transmission resource, and the usage of SRSs transmitted on the SRS resource set. In some cases, the descriptions of “SRS resource” and “SRS” may be interchangeable.

In some implementations, the first configuration information used for configuring the multiple SRS resources or the multiple SRS resource sets (or the configuration information of the multiple SRS resources or the multiple SRS resource sets) is carried in the high-level signaling, which may be the RRC signaling.

In embodiments of the disclosure, for each SRS resource of the multiple SRS resources, the configuration information of the SRS resource may contain the transmission mode, the transmission resource, and the usage of this SRS resource, which is not limited to thereto. Optionally, the configuration information of the SRS resource may also contain other information, such as the resource type of this SRS resource. The resource type may be configured to be aperiodic, semi-persistent, or periodic. For each SRS resource set of the multiple SRS resource sets, the configuration information of the SRS resource set includes configuration information of each SRS resource within the SRS resource set. The configuration information of each SRS resource may contain the transmission mode, the transmission resource, and the usage of the SRS resource, which is not limited to thereto. Optionally, the configuration information of each SRS resource may also contain other information, such as the resource type of the SRS resource. The resource type may be configured to be aperiodic, semi-persistent, or periodic.

In embodiments of the disclosure, the multiple SRS resources or the multiple SRS resource sets are configured with the same transmission mode, the same transmission resource, and the same usage. The terminal device sends SRSs on multiple SRS resources or multiple SRS resource sets by means of the same transmission mode and the same transmission resource, and the SRSs sent on the multiple SRS resources or the multiple SRS resource sets have phase consistency.

In some implementations, the same transmission mode includes at least one of the following: the same transmit power; the same power control parameter; the same spatial related parameter; the same number of antenna ports; or the same antenna ports.

Herein, “the same transmit power” and “the same power control parameter” may be interchangeable. For example, a case that the terminal device sends the SRSs on the multiple SRS resources or the multiple SRS resource sets using the same power control parameter can be replaced by a case that the terminal device sends the SRSs on the multiple SRSs resources or the multiple SRS resource sets using the same transmit power.

In some implementations, the power control parameter includes one or more of the following parameters: an open-loop power control parameter, a path loss reference signal, and a closed-loop power control parameter. Exemplarily, the open-loop power control parameter may include a target power Po, a path loss factor a, etc, and the closed-loop power control parameter may include a power adjustment state index l, etc.

In some implementations, the transmit power may be determined according to the power control parameter. Exemplarily, the transmit power of the SRS may be determined according to the following formula:

$${P}_{SRS , b , f , c} ( i , {q}_{s ,} l ) = min \{ \begin{matrix}{P}_{CMAX , f , c} ( i ) , \\ {P}_{o \_ SRS , b , f , c} ( {q}_{s} ) + 10 {log}_{10} ( {2}^{μ} \cdot {M}_{SRS , b , f , c} ( i ) ) + \\ {α}_{SRS , b , f , c} ( {q}_{s} ) + {PL}_{b , f , c} ( {q}_{d} ) + {h}_{b , f , c} ( i , l )\end{matrix} \} [ dBm ]$$

The parameters in the above formula are explained below, which may be considered as power control parameters.

P_{CMAX,f,c} (i) represents the maximum transmit power configured for the terminal device on carrier f, serving cell c, and SRS sending slot i.

P_{o_SRS,b,f,c} (As) represents the Po value configured for the SRS resource set qₛ on carrier f, BWP b, and serving cell c.

M_{SRS,b,f,c} (i) represents the number of SRS RBs configured on carrier f, BWP b, and serving cell c, and on SRS sending slot i.

α_{SRS,b,f,c} (qₛ) represents the alpha value (i.e. the path loss factor) configured for the SRS resource set qₛ on carrier f, BWP b, and serving cell c.

PL_{b,f,c} (q_{d}) represents the reference signal calculation path loss configured for the SRS resource set q_{d} on carrier f, BWP b, and serving cell c.

h_{b,f,c} (i,l) represents the power adjustment value of the power adjustment state 1 on carrier f, BWP b, serving cell c, and SRS sending slot i.

Herein, “spatial related parameter” may also be described as “spatial related information”, which may indicate a CSI-RS, an SSB, a reference SRS, or a transmission configuration indication (TCI) state. The terminal device determines the transmitting beam of the target SRS resource according to the receiving beam of the CSI-RS/SSB indicated by the spatial related parameter, or the terminal device determines the transmitting beam of the target SRS resource according to the transmitting beam of the reference SRS resource, or the terminal device determines the transmitting beam of the target SRS resource according to the indication of the TCI state. Herein, the receiving beam may be replaced by a spatial receiving filter, and the transmitting beam may be replaced by a spatial transmission filter.

In some implementations, the same transmission resource includes at least one of the following: a same symbol index; a same frequency domain resource; a same frequency hopping configuration; a same cyclic shift; or a same SRS base sequence.

Herein, the same symbol index may be understood as that the symbols where the SRSs transmitted on the multiple SRS resources or the multiple SRS resource sets are located have the same symbol index. Exemplarily, the symbol index may be determined by configuring the following parameters: the symbol starting position and the number of symbols.

Herein, the same frequency domain resource may be understood as that the SRSs transmitted on the multiple SRS resources or the multiple SRS resource sets are located on the same frequency domain resource. Exemplarily, the frequency domain resource may be determined by configuring the following parameters: a frequency band, a PRB, a comb structure, and a comb offset.

Herein, the same frequency hopping configuration may be understood as that the SRSs transmitted on the multiple SRS resources or the multiple SRS resource sets have the same frequency hopping parameter.

Herein, the same cyclic shift may be understood as that the SRSs transmitted on the multiple SRS resources or the multiple SRS resource sets have the same cyclic shift.

Herein, the same SRS base sequence may be understood as that the SRSs transmitted on the multiple SRS resources or the multiple SRS resource sets have the same SRS base sequence.

In some implementations, the above usages include at least one of the following: channelPrediction, downlink channel prediction (DLchannelPrediction), uplink channel prediction (ULchannelPrediction), TDCP measurement, or antennaSwitching.

Herein, the channel prediction may be understood as ULchannelPrediction, or DLchannelPrediction, or both ULchannelPrediction and DLchannelPrediction according to the protocol agreement.

In some implementations, the SRSs sent on the multiple SRS resources or the multiple SRS resource sets mentioned above have phase consistency, and the phase consistency may also be replaced with other descriptions of same essence. Exemplarily, the following descriptions may be used for replacement.

The first alternative description is that the SRSs sent on the multiple SRS resources or the multiple SRS resource sets are coherent.

The second alternative description is that the relative phase change of the SRSs sent on the multiple SRS resources or the multiple SRS resource sets is within a certain range.

The third alternative description is that during the sending of the SRSs on the multiple SRS resources or the multiple SRS resource sets, the relative phase change of the transmitting antenna of the terminal device is within a certain range.

That is to say, the network device may assume that the SRSs sent on the multiple SRS resources or the multiple SRS resource sets are sent through the same antenna port.

Exemplarily, if the sequence of SRSs sent on a first SRS resource is identical to the sequence of SRSs sent on a second SRS resource, and the relative phase change of the transmitting antennas of these SRSs are within a certain range, these SRSs can be regarded to have phase consistency or be coherent.

Exemplarily, if the sequence of SRSs sent on a first SRS resource set (which may contain one or more SRS resources) are identical to the sequence of SRSs sent on a second SRS resource set (which may contain one or more SRS resources), and the relative phase change of these SRSs are within a certain range, these SRSs can be regarded to have phase consistency or be coherent.

It should be noted that the relative phase change may also be understood as a change in phase difference. The relative phase change refers a relative phase change of the SRSs sent by the terminal device on the multiple SRS resources or the multiple SRS resource sets.

In some implementations, the metric (or requirement) of the phase consistency mentioned above may be defined by the protocol or configured by the network device. The metric of the phase consistency may be defined by a threshold p, or defined by a duration t and the threshold p.

Exemplarily, if the relative phase change does not exceed the threshold p, the metric of the phase consistency is satisfied; otherwise, the metric of the phase consistency etric is not satisfied.

Exemplarily, if the relative phase change does not exceed the threshold p within the duration t, the metric of the phase consistency is satisfied; otherwise, the metric of the phase consistency is not satisfied. For example, if the relative phase change of the signal sent by the transmitting antenna of the terminal device within the duration t does not exceed the threshold value p, the signal satisfies the metric of the phase consistency, and thus the signal has the phase consistency; otherwise, the signal does not have the phase consistency.

In some implementations, the terminal device sends UE capability information to the network device. The UE capability information indicates a maximum time length in which the terminal device can maintain the phase consistency. Accordingly, the network device receives the UE capability information sent by the terminal device. The UE capability information indicates the maximum time length in which the terminal device can maintain the phase consistency.

In some implementations, if the maximum time length in which the terminal device can maintain the phase consistency indicated by the UE capability information sent by the terminal device to the network device is a specific value, such as 1, it indicates that the terminal device does not support the phase consistency. At this point, the network device will not configure, for the terminal device, SRS resources or SRS resource sets for ULchannelPrediction, or DLchannelPrediction, or TDCP measurement as described in embodiments of the disclosure.

Exemplarily, the maximum time length may be in units of slots, symbols (such as OFDM symbols), or milliseconds (ms).

In some implementations, the terminal device does not expect that a duration length (or the total duration length) corresponding to the multiple SRS resources or the multiple SRS resource sets exceeds the maximum time length in which the terminal device can maintain the phase consistency. It can be understood that if the duration length corresponding to the multiple SRS resources or the multiple SRS resource sets does not exceed the maximum time length in which the terminal device can maintain the phase consistency, the capability of the terminal device supports that the SRSs sent on the multiple SRS resources or the multiple SRS resource sets have the phase consistency.

In some implementations, the network device sends first indication information to the terminal device. The first indication information indicates a first time length, which is a time length required for the terminal device to maintain the phase consistency or a time length required for the network device to measure the SRSs. Accordingly, the terminal device receives the first indication information sent by the network device. The first indication information indicates the first time length. The terminal device maintains the phase consistency for the SRSs sent on the multiple SRS resources or the multiple SRS resource sets within the first time length.

Exemplarily, the first indication information may be carried in high-level signaling (such as the RRC signaling) or DCI.

Exemplarily, the first time length mentioned above may be in units of slots, symbols (such as OFDM symbols), or ms.

In some implementations, the first time length is less than or equal to the maximum time length in which the terminal device can maintain the phase consistency, or the first time length is less than or equal to the maximum time length in which the phase consistency is maintained reported by the terminal device.

In some implementations, the terminal device maintains the phase consistency for the SRSs sent on the multiple SRS resources or the multiple SRS resource sets within the first time length, which may be implemented as follows.

In the first mode, the terminal device maintains the phase consistency for the SRSs sent on the multiple SRS resources or the multiple SRS resource sets within any time window with the first time length.

For the first mode, the time domain position of the time window with the first time length is arbitrary, and different time windows may be completely non-overlapping or partially overlapping. In case where different time windows are completely non-overlapping, different time windows may be adjacent or there is an interval between different time windows.

In the second mode, the terminal device maintains the phase consistency for the SRSs sent on the multiple SRS resources or the multiple SRS resource sets within each time window with the first time length starting from a first time domain position. The first time domain position is determined based on a first time domain offset. The first time domain offset is configured by the network device, is defined by the protocol, or is pre-configured.

The first time domain offset may be either a slot offset or a symbol offset. The symbol offset may be an OFDM symbol offset.

For the second mode, the time domain position of the time window with the first time length is periodic, and the period may be the same as or different from the first time length. In case where the period is the same as the first time length, the time windows within adjacent periods are adjacent. In case where the period is longer than the first time length, there is an interval between the time windows within adjacent periods.

In an embodiment of the disclosure, the SRS resources in the multiple SRS resources may be aperiodic SRS resources, or periodic SRS resources, or semi-persistent SRS resources. The SRS resource sets in the multiple SRS resource sets may be aperiodic SRS resource sets, or periodic SRS resource sets, or semi-persistent SRS resource sets. Here, the aperiodic SRS resource set is an SRS resource set that contains aperiodic SRS resources, the periodic SRS resource set is an SRS resource set that contains periodic SRS resources, and the semi-persistent SRS resource set is an SRS resource set that contains semi-persistent SRS resources.

The implementation of multiple SRS resources is explained below.

In some implementations, the SRS resources in the multiple SRS resources are aperiodic SRS resources triggered by the same signaling. Exemplarily, the signaling may be DCI.

In some cases, the above signaling is also used for scheduling a PUSCH, and the above SRSs on the multiple SRS resources are used for predicting channel state information of the PUSCH. In other cases, the above signaling is also used for scheduling a PDSCH, and the above SRSs on the multiple SRS resources are used for predicting channel state information of the PDSCH.

In some implementations, the DCI used for triggering the aperiodic SRS resources may be DCI (i.e. DCI format 0_1, 1_0) used for scheduling PUSCH/PDSCH in the UE dedicated search space, or may be DCI format 2_3 in the common search space. Herein, DCI format 2_3 may not only be used for triggering the aperiodic SRS resources, but also simultaneously configuring the TPC command for the SRS on a group of terminal devices or a group of carriers.

In some implementations, the aperiodic SRS resources may be triggered through the SRS request field in the DCI. The length of the SRS request field is X bits, for example, X=2 or X=3. The value of X bits in the SRS request field may indicate the triggered SRS resources. Specifically, the value indicates which SRS resources configured by the network device through the RRC signaling are triggered. Taking the length of the SRS request field being 2 bits as an example, the above Table 1 provides the meanings corresponding to different values of the SRS request field.

In other implementations, the SRS resources in the multiple SRS resources are semi-persistent SRS resources or periodic SRS resources with the same period.

In some implementations, adjacent two SRS resources in the multiple SRS resources are separated by the same number of symbols or the same number of slots in the time domain. Here, the symbol may be an OFDM symbol.

Exemplarily, the number of symbols is configured by the network device, is defined by the protocol, or is pre-configured.

Exemplarily, the number of slots is configured by the network device, is defined by the protocol, or is pre-configured.

The implementation of multiple SRS resource sets is explained below.

In some implementations, the SRS resource sets in the multiple SRS resource sets are aperiodic SRS resource sets triggered by the same signaling. Exemplarily, the signaling may be DCI.

In some cases, the above signaling is also used for scheduling a PUSCH, and the above SRSs on the multiple SRS resource sets are used for predicting channel state information of the PUSCH. In other cases, the above signaling mentioned is also used for scheduling a PDSCH, and the above SRSs on the multiple SRS resource sets are used for predicting channel state information of the PDSCH.

In some implementations, the DCI used for triggering the aperiodic SRS resource sets may be DCI (i.e. DCI format 0_1, 1_0) used for scheduling PUSCH/PDSCH in the UE dedicated search space, or may be DCI format 2_3 in the common search space. Herein, DCI format 2_3 may not only be used for triggering the aperiodic SRS resource sets, but also simultaneously configuring the TPC command for the SRS on a group of terminal devices or a group of carriers.

In some implementations, the aperiodic SRS resource sets may be triggered through the SRS request field in the DCI. The length of the SRS request field is X bits, exemplarily, X=2 or X=3. The value of X bits in the SRS request field may indicate the triggered SRS resource sets. Specifically, the value indicates which SRS resource sets configured by the network device through the RRC signaling are triggered. Taking the length of the SRS request field being 2 bits as an example, the above Table 1 provides the meanings corresponding to different values of the SRS request field.

In other implementations, the SRS resource sets in the multiple SRS resource sets are semi-persistent SRS resource sets or periodic SRS resource sets with the same period.

In some implementations, adjacent two SRS resource sets in the multiple SRS resource sets are separated by the same number of symbols or the same number of slots in the time domain. Here, the symbol may be the OFDM symbol.

Exemplarily, the above number of symbols is configured by the network device, is defined by the protocol, or is pre-configured.

Exemplarily, the above number of slots is configured by the network device, is defined by the protocol, or is pre-configured.

Through the above solution, after the network device receives the SRSs sent by the terminal device on the multiple SRS resources or the multiple SRS resource sets, the network device performs at least one of the following operations based on received SRSs in some implementations: uplink channel state information prediction, downlink channel state information prediction, or TDCP measurement.

Here, the usage of the multiple SRS resources or the multiple SRS resource sets is related to the operations performed by the network device based on the received SRSs. For example, if the usage of the multiple SRS resources or the multiple SRS resource sets is “channel prediction” or “ULchannelPrediction”, the network device performs the uplink channel state information prediction based on the received SRSs. For example, if the usage of the multiple SRS resources or the multiple SRS resource sets is “antennaSwitching”, or “channel prediction”, or “DLchannelPrediction”, the network device performs the downlink channel state information prediction based on the received SRSs. For example, if the usage of the multiple SRS resources or the multiple SRS resource sets is “TDCP measurement (TDCP for short)”, the network device performs TDCP measurement based on the received SRSs.

In the technical solution of embodiments of the disclosure, the terminal device sends SRSs using the same transmission mode and transmission resource on multiple SRS resources or SRS resource sets configured by the network device, and the sent SRSs have phase consistency. Based on the received SRSs, the network device may perform uplink channel state information prediction, or downlink channel state information prediction, or TDCP measurement, thereby avoiding the terminal device from performing frequent SRS transmission due to the channel change and saving SRS resource overhead, and further reducing the delay of channel prediction, and improving the accuracy of ULchannelPrediction or DLchannelPrediction. In another aspect, based on the SRS transmission method of the disclosure, the network device may perform TDCP measurement based on the SRSs to configure uplink and downlink transmission, and thus avoid TDCP measurement and feedback based on the TRS, thereby not only saving the overhead of TRS resources and feedback signaling, but also reducing the implementation complexity of the terminal device.

The technical solution of embodiments of the disclosure is illustrated by example below in conjunction with specific application examples. In the first application example below, SRSs on multiple SRS resources or SRS resource sets are used for ULchannelPrediction (i.e., uplink channel state information prediction). In the second application example below, SRSs on multiple SRS resources or SRS resource sets are used for DLchannelPrediction (i.e., downlink channel state information prediction). In the third application example below, SRSs on multiple SRS resources or SRS resource sets are used for TDCP measurement.

### First Application Example

In this application example, the SRSs on multiple SRS resources or SRS resource sets are used for ULchannelPrediction (i.e., uplink channel state information prediction), as shown in FIG. 5. This application example includes one or more of the following operations.

At 501, a network device configures multiple SRS resources or multiple SRS resource sets. The multiple SRS resources or SRS resource sets are configured with a same transmission mode, a same transmission resource, and a same usage.

At 502, a terminal device receives the multiple SRS resources or the multiple SRS resource sets configured by the network device.

At 503, the terminal device sends SRSs on the multiple SRS resources or the multiple SRS resource sets. The SRSs sent on the multiple SRS resources or the multiple SRS resource sets adopt the same transmission mode and the same transmission resource, and have phase consistency.

The same transmission mode is explained below.

In some implementations, in case where the network device configures multiple SRS resources, the SRSs on the multiple SRS resources adopting the same transmission mode includes at least one of the following cases.

1. The SRSs on the multiple SRS resources adopt the same transmit power.

Here, the network device configures the same power control parameter for the multiple SRS resources, and the terminal device adopts the same transmit power to send the SRSs on the multiple SRS resources according to the configuration of the network device.

2. The SRSs on the multiple SRS resources adopt the same transmitting beam (which may also be described as a spatial transmission filter).

Here, the network device configures the same spatial related parameter (or referred to spatial related information) or the same TCI state for the multiple SRS resources, and the terminal device adopts the same transmitting beam (which may also be described as the spatial transmission filter) to send the SRSs on the multiple SRS resources according to the configuration of the network device.

3. The SRSs on the multiple SRS resources adopt the same number of antenna ports.

Here, the network device configures the same number of antenna ports for the multiple SRS resources, and the terminal device adopts the same number of antenna ports to send the SRSs on the multiple SRS resources according to the configuration of the network device.

4. The SRSs on the multiple SRS resources adopt the same antenna port.

Here, the network device configures the same antenna port for the multiple SRS resources, and the terminal device adopts the same antenna port to send the SRSs on the multiple SRS resources according to the configuration of the network device. That is to say, the terminal device adopts the same antenna port to transmit SRSs on different SRS resources, and the network device may assume that the identical precoding matrix/beams are used for sending SRSs on different SRS resources.

Exemplarily, the SRSs on the multiple SRS resources adopting the same transmission mode may be that the SRSs on the multiple SRS resources adopt the same transmit power, the same transmitting beam, and the same number of antenna ports.

Exemplarily, the SRSs on the multiple SRS resources adopting the same transmission mode may be that the SRSs on the multiple SRS resources adopt the same transmit power, the same transmitting beam, and the same antenna port.

The above examples are only for illustration purposes, and the technical solution of embodiments of the disclosure may also have other combinations.

In some implementations, in case where the network device configures multiple SRS resource sets, the SRSs on the multiple SRS resource sets adopting the same transmission mode includes at least one of the following cases.

1. The SRSs on the multiple SRS resource sets adopt the same transmit power.

Here, the network device configures the same power control parameter for the multiple SRS resource sets, and the terminal device adopts the same transmit power to send the SRSs on the multiple SRS resource sets according to the configuration of the network device.

2. The SRSs on the multiple SRS resource sets adopt the same transmitting beam (which may also be described as a spatial transmission filter).

Here, the network device configures the same spatial related parameter (or referred to as spatial related information) or the same TCI state for SRS resources in the multiple SRS resource sets, and the terminal device adopts the same transmitting beam (which may also be described as the spatial transmission filter) to send the SRSs on the multiple SRS resource sets according to the configuration of the network device. In an example, the network device may also configure the same associated CSI-RS for SRS resources in the multiple SRS resource sets, so that the terminal device may determine the same precoding matrix and transmitting beam (which may also be described as the spatial transmission filter) for the SRS resources in the SRS resource sets according to the same associated CSI-RS.

3. The SRSs on the multiple SRS resource sets adopt the same number of antenna ports.

Here, the network device configures the same number of antenna ports for the SRS resources in the multiple SRS resource sets, and the terminal device adopts the same number of antenna ports to send SRSs on the multiple SRS resource sets according to the configuration of the network device.

4. The SRSs on the multiple SRS resource sets adopt the same antenna port.

Here, the network device configures the same antenna port for SRS resources in the multiple SRS resource sets, and the terminal device adopts the same antenna port to send SRSs on the multiple SRS resource sets according to the configuration of the network device. That is to say, the terminal device adopts the same antenna port to transmit SRSs on different SRS resource sets, and the network device may assume that the identical precoding matrixes/beams are used for sending SRSs on different SRS resource sets.

Exemplarily, the SRSs on the multiple SRS resource sets adopting the same transmission mode may be that the SRSs on the multiple SRS resource sets adopt the same transmit power, the same transmitting beam, and the same number of antenna ports.

Exemplarily, the SRSs on the multiple SRS resource sets adopting the same transmission mode may be that the SRSs on the multiple SRS resource sets adopt the same transmit power, the same sending beam, and the same antenna port.

The above examples are only for illustration purposes, and the technical solution of embodiments of the disclosure may also have other combinations.

The same transmission resource is explained below.

In some implementations, in case where the network device configures multiple SRS resources, the SRSs on the multiple SRS resources adopting the same transmission resource includes at least one of the following cases

1. The SRSs on the multiple SRS resources adopt the same OFDM symbol index.

Here, the network device configures the same OFDM symbol index for the multiple SRS resources. Exemplarily, the network device may configure the same symbol starting position and the same number of OFDM symbols for the multiple SRS resources to configure the same OFDM symbol index. The terminal device adopts the same OFDM symbol index to send the SRSs on the multiple SRS resources according to the configuration of the network device.

2. The SRSs on the multiple SRS resources adopt the same frequency domain resource.

Here, the network device configures the same frequency domain resource for the multiple SRS resources. Exemplarily, the network device may configure the same frequency band, the same PRB, the same comb structure, the same comb offset, etc. for the multiple SRS resources to configure the same frequency domain resource. The terminal device adopts the same frequency domain resource to send the SRSs on the multiple SRS resources according to the configuration of the network device.

3. The SRSs on the multiple SRS resources adopt the same frequency hopping configuration.

Here, the network device configures the same frequency hopping parameter for the multiple SRS resources. The terminal device adopts the same frequency hopping configuration to send the SRSs on the multiple SRS resources according to the configuration of the network device.

Exemplarily, the SRSs on the multiple SRS resources adopting the same transmission resource may be that the SRSs on the multiple SRS resources adopt the same OFDM symbol index and the same frequency domain resource.

Exemplarily, the SRSs on the multiple SRS resources adopting the same transmission resource may be that the SRSs on the multiple SRS resources adopt the same OFDM symbol index, the same frequency domain resource, and the same frequency hopping configuration.

The above examples are only for illustration purposes, and the technical solution of embodiments of the disclosure may also have other combinations.

In some implementations, in case where the network device configures multiple SRS resource sets, the SRSs on the multiple SRS resource sets adopting the same transmission resource includes at least one of the following cases.

1. The SRSs on the multiple SRS resource sets adopt the same OFDM symbol index.

Here, the network device configures the same OFDM symbol index for SRS resources in the multiple SRS resource sets. Exemplarily, the network device may configure the same symbol starting position and the same number of OFDM symbols to configure the same OFDM symbol index. The terminal device adopts the same OFDM symbol index to send the SRSs on the multiple SRS resource sets according to the configuration of the network device.

2. The SRSs on the multiple SRS resource sets adopt the same frequency domain resource.

Here, the network device configures the same frequency domain resource for SRS resources in the multiple SRS resource sets. Exemplarily, the network device may configure the same frequency band, the same PRB, the same comb structure, the same comb offset, etc. to configure the same frequency domain resource. The terminal device adopts the same frequency domain resource to send the SRSs on the multiple SRS resource sets according to the configuration of the network device.

3. The SRSs on the multiple SRS resource sets adopt the same frequency hopping configuration.

Here, the network device configures the same frequency hopping parameter for SRS resources in the multiple SRS resource sets. The terminal device adopts the same frequency hopping configuration to send the SRSs on the multiple SRS resource sets according to the configuration of the network device.

Exemplarily, the SRSs on the multiple SRS resource sets adopting the same transmission resource may be that the SRSs on the multiple SRS resource sets adopt the same OFDM symbol index and the same frequency domain resource.

Exemplarily, the SRSs on the multiple SRS resource sets adopting the same transmission resource may be that the SRSs on the multiple SRS resource sets adopt the same OFDM symbol index, the same frequency domain resource, and the same frequency hopping configuration.

In the technical solution of embodiments of the disclosure, when the SRSs on the multiple SRS resources or the multiple SRS resource sets adopt the same transmission mode and transmission resource, the network device may perform accurate ULchannelPrediction according to these SRSs to obtain uplink channel state information (such as a precoding matrix) at a certain future moment. If the transmission modes or transmission resources are different, the accuracy of channel prediction will seriously deteriorate.

The same usage is explained below.

In some implementations, the multiple SRS resources or the multiple SRS resource sets are configured by a network device for a same usage.

In some implementations, the network device configures the multiple SRS resources or the multiple SRS resource sets for the same usage through high-level signaling.

Exemplarily, for the above multiple SRS resources or the multiple SRS resource sets, the network device may define a new usage which is distinguishes from the usage configuration supported in the existing protocols. For example, the usage of the multiple SRS resources or the multiple SRS resource sets may be configured to be “channel prediction” or “ULchannelPrediction”.

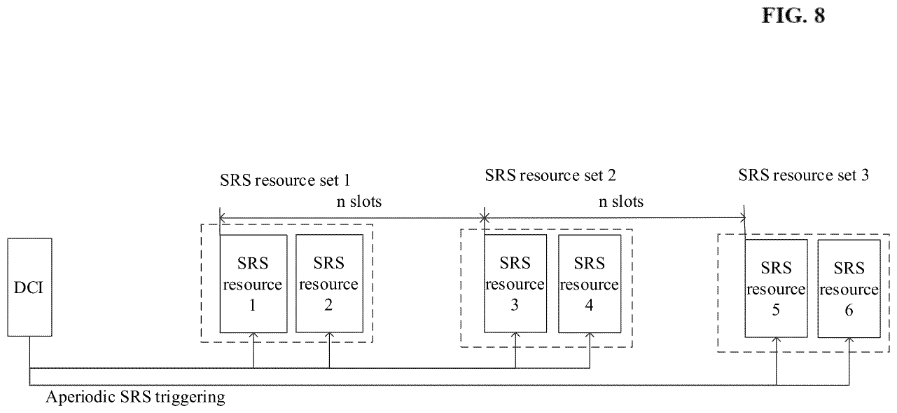

In some implementations, the multiple SRS resources or the multiple SRS resource sets are aperiodic SRS resources or aperiodic SRS resource sets triggered by the same DCI. That is to say, these SRS resources or SRS resource sets correspond to identical aperiodic trigger states. Exemplarily, as shown in FIGS. 6 and 8, 4 SRS resources are aperiodic SRS resources triggered by one piece of DCI in FIGS. 6, and 3 SRS resource sets are aperiodic SRS resource sets triggered by the same piece of DCI in FIG. 8. At this point, SRSs sent on aperiodic SRS resources or SRS resource sets triggered by one piece of DCI have phase consistency.

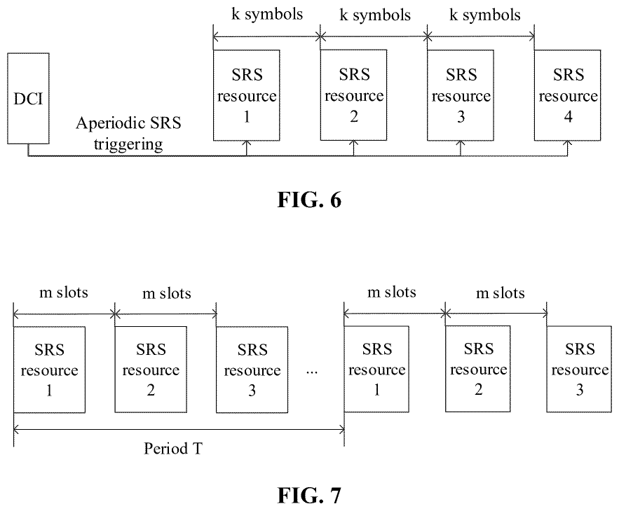

In other implementations, the multiple SRS resources are semi-persistent SRS resources or periodic SRS resources with the same period, or the multiple SRS resource sets are semi-persistent SRS resource sets or periodic SRS resource sets with the same period. As shown in FIG. 7, all 3 SRS resources are periodic SRS resources with a period of T.

In some implementations, the multiple SRS resources or the multiple SRS resource sets are separated by the same number of symbols or the same number of slots in the time domain. Here, the same number of slots may be obtained by configuring the slot offset of SRS resources or configuring the trigger slot offset of SRS resource sets through the network device. For example, multiple SRS resources may be separated by k symbols, as shown in FIG. 6. For example, multiple SRS resources may be separated by m slots, as shown in FIG. 7. For example, multiple SRS resource sets may be separated by n slots, as shown in FIG. 8. That is to say, in FIG. 8, the slot offsets of the 3 SRS resource sets triggered by the DCI are j, n+j, and 2n+j.

In the above examples, the value of k/m/n may be indicated by the network device to the terminal device, and a value range may be predetermined. For example, the value range of m and n may be 1 and 2, where 1 represents adjacent slots and 2 represents that an interval is one slot.

The phase consistency is explained below.

In some implementations, the above SRSs sent on the multiple SRS resources or the multiple SRS resource sets have phase consistency, and the phase consistency may also be replaced with other descriptions of same essence. Exemplarily, the following descriptions may be used for replacement.

The first alternative description is that the SRSs sent on the multiple SRS resources or the multiple SRS resource sets are coherent.

The second alternative description is that the relative phase change of the SRSs sent on the multiple SRS resources or the multiple SRS resource sets is within a certain range.

The third alternative description is that during the sending of the SRSs on the multiple SRS resources or the multiple SRS resource sets, the relative phase change of the transmitting antenna of the terminal device is within a certain range.

That is to say, the network device may assume that the SRSs sent on the multiple SRS resources or the multiple SRS resource sets are sent through the same antenna port.

Exemplarily, if the sequence of SRSs sent on a first SRS resource is identical to the sequence of SRSs sent on a second SRS resource, and the relative phase change of the transmitting antennas of these SRSs are within a certain range, these SRSs can be regarded to have phase consistency or be coherent.

Exemplarily, if the sequence of SRSs sent on a first SRS resource set (which may contain one or more SRS resources) is identical to the sequence of SRSs sent on a second SRS resource set (which may contain one or more SRS resources), and the relative phase changes of the SRSs are within a certain range, the SRSs can be regarded to have phase consistency or be coherent.

It should be noted that the relative phase change may also be understood as a change in a phase difference. The relative phase change refers a relative phase change of the SRSs sent by the terminal device on the multiple SRS resources or the multiple SRS resource sets.

In some implementations, the metric (or requirement) of the above phase consistency may be defined by the protocol or configured by the network device. The metric of the phase consistency may be defined by a threshold p, or defined by a duration t and the threshold p.

Exemplarily, if the relative phase change does not exceed the threshold p, the metric of the phase consistency is satisfied, and otherwise, the metric of the phase consistency is not satisfied.

Exemplarily, if the relative phase change does not exceed the threshold p within the duration t, the metric of the phase consistency is satisfied, and otherwise, the metric of the phase consistency is not satisfied. For example, if the relative phase change of the signal sent by the transmitting antenna of the terminal device within the duration t does not exceed the threshold value p, the signal satisfies the metric of the phase consistency, and thus the signal has the phase consistency, and otherwise, the signal does not have the phase consistency.

In the technical solution of embodiments of the disclosure, if the SRSs sent on the multiple SRS resources or the multiple SRS resource sets have the phase consistency, the network device may perform accurate channel prediction according to the SRSs and obtain the channel state information at a certain future moment; and otherwise, if the SRSs do not have the phase consistency, the accuracy of channel prediction will seriously deteriorate.

In some implementations, the terminal device reports a maximum time length in which the terminal device can maintain the phase consistency to the network device. The terminal device does not expect that a total duration of the multiple SRS resources or the multiple SRS resource sets exceeds the maximum time length in which the phase consistency can be maintained reported by the terminal device. The restriction applies at least to the case where the multiple SRS resources or the multiple SRS resource sets are aperiodic SRS resources or aperiodic SRS resource sets, that is to say, the time length of a single SRS transmission triggered by the DCI does not exceed the maximum time length in which the terminal device can maintain the phase consistency.

In some implementations, if the maximum time length reported by the terminal device to the network device is a specific value, such as 1, it indicates that the terminal device does not support the phase consistency. In this case, the network device will not or cannot configure the above multiple SRS resources or the above multiple SRS resource sets for the terminal device to perform ULchannelPrediction.

Exemplarily, the above maximum time length may be in units of slots, symbols (such as OFDM symbols), or ms.

In some implementations, the terminal device receives a first time length indicated by the network device. Exemplarily, the network device may indicate the first time length through high-level signaling (such as the RRC signaling) or DCI. The SRSs sent by the terminal device on the multiple SRS resources or the multiple SRS resource sets within the first time length need to maintain the phase consistency. This solution may at least be applied to the cases where the multiple SRS resources or SRS resource sets are periodic or semi-persistent SRS resources or periodic or semi-persistent SRS resource sets.

Exemplarily, the above first time length may be in units of slots, symbols (such as OFDM symbols), or ms.

In some implementations, the first time length is less than or equal to the maximum time length in which the phase consistency is maintained reported by the terminal device.

In some implementations, the SRSs sent by the terminal device on the multiple SRS resources or the multiple SRS resource sets within any time window with the first time length maintain the phase consistency. Exemplarily, as shown in FIG. 9, the first time length is P, and the terminal device needs to ensure that the SRSs sent on the SRS resources or SRS resource sets have the phase consistency within any time window with length P (the time windows indicated by the dashed boxes). In FIG. 9, all 3 SRS resources are semi-persistent SRS resources or periodic SRS resources with a period of T.

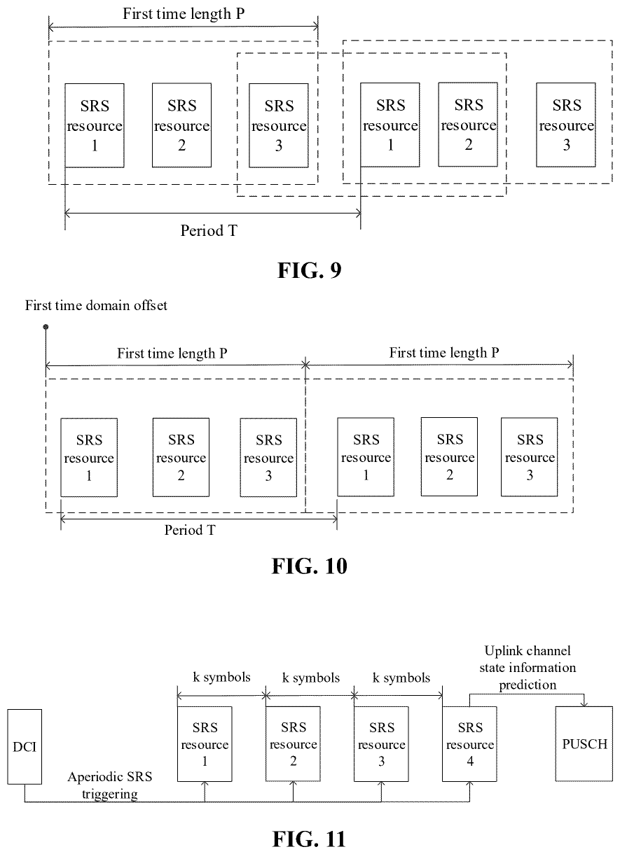

In other implementations, the SRSs sent by the terminal device on the multiple SRS resources or the multiple SRS resource sets within each time window of the first time length starting from a first time domain offset maintain the phase consistency. Herein, the first time domain offset may be indicated by the network device to the terminal device. The first time domain offset may be either a slot offset or a symbol offset, which indicates the starting point of the first time window. SRSs sent within the first time window and each subsequent time window maintain the phase consistency. SRSs within each time window with the length P have the phase consistency, and each time window with the length P is the time window in which the network device performs ULchannelPrediction. Exemplarily, as shown in FIG. 10, the first time length is P. The starting point of the first time window is determined based on the first time domain offset. The terminal device needs to ensure that the SRSs sent on the SRS resources or SRS resource sets have the phase consistency within each time window with the length P (the time windows indicated by the dashed boxes). In FIG. 10, all 3 SRS resources are semi-persistent SRS resources or periodic SRS resources with a period of T.

In the technical solution of embodiments of the disclosure, the network device indicates the first time length less than or equal to the maximum time length in which the phase consistency is maintained reported by the terminal device, which can effectively reduce the implementation complexity of the terminal device. The terminal device only needs to ensure that the SRSs have the phase consistency within a relatively short time window (i.e., the measurement time window of the network device).

At 504, the network device receives the SRSs sent by the terminal device on the multiple SRS resources or the multiple SRS resource sets.

At 505, the network device performs uplink channel state information prediction according to received SRSs.

In some implementations, the network device may predict the uplink channel state information after X (X≥1) slots according to the uplink channel state information measured based on several SRSs separated by equal intervals in the time domain. The network device schedules the PUSCH after X slots using the predicted uplink channel state information, thereby avoiding performance loss caused by the delay of the uplink channel state information. Exemplarily, as shown in FIG. 11, 4 SRS resources are separated by k symbols in the time domain. The 4 SRS resources are aperiodic SRS resources triggered by the same DCI. SRSs sent by the terminal device on the 4 SRS resources adopt the same transmission mode and the same transmission resource, and have the phase consistency. The network device may receive the SRSs on the 4 SRS resources, predict the uplink channel state information after X (X≥1) slots based on the received SRSs, and schedule the PUSCH after X slots according to the uplink channel state information. Here, one piece of DCI is used to schedule the PUSCH and trigger multiple SRS resources, thereby saving the overhead of downlink control signaling.

### Second Application Example

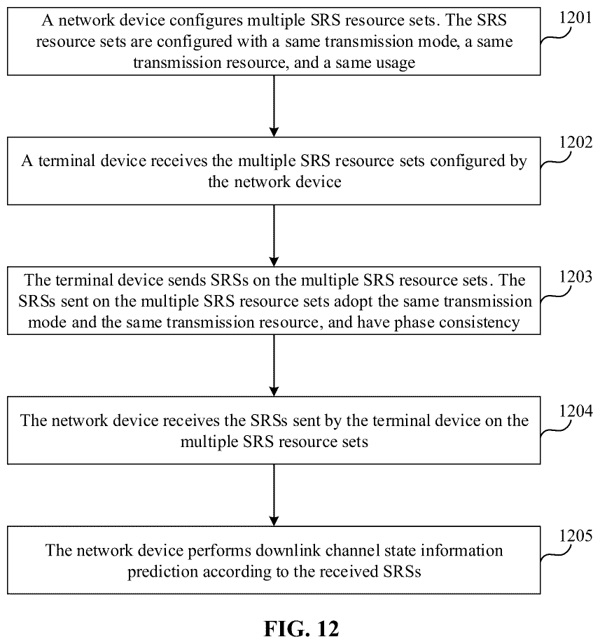

In this application example, SRSs on multiple SRS resource sets are used for DLchannelPrediction (i.e., downlink channel state information prediction), as shown in FIG. 12. This application example includes one or more of the following operations.

At 1201, a network device configures multiple SRS resource sets. The SRS resource sets are configured with a same transmission mode, a same transmission resource, and a same usage.

At 1202, a terminal device receives the multiple SRS resource sets configured by the network device.

At 1203, the terminal device sends SRSs on the multiple SRS resource sets. The SRSs sent on the multiple SRS resource sets adopt the same transmission mode and the same transmission resource, and have phase consistency.

The same transmission mode is explained below.

In some implementations, in case where the network device configures multiple SRS resources, the SRSs on the multiple SRS resources adopting the same transmission mode includes at least one of the following cases.

1. The SRSs on the multiple SRS resources adopt the same transmit power.

Here, the network device configures the same power control parameter for the multiple SRS resources, and the terminal device adopts the same transmit power to send the SRSs on the multiple SRS resources according to the configuration of the network device.

2. The SRSs on the multiple SRS resources adopt the same transmitting beam (which may also be described as a spatial transmission filter).

Here, the network device configures the same spatial related parameter (or referred to as spatial related information) or the same TCI state for the multiple SRS resources, and the terminal device adopts the same transmitting beam (which may also be described as the spatial transmission filter) to send the SRSs on the multiple SRS resources according to the configuration of the network device.

3. The SRSs on the multiple SRS resources adopt the same number of antenna ports.

Here, the network device configures the same number of antenna ports for the multiple SRS resources, and the terminal device adopts the same number of antenna ports to send the SRSs on the multiple SRS resources according to the configuration of the network device.

4. The SRSs on the multiple SRS resources adopt the same antenna port.

Here, the network device configures the same antenna port for the multiple SRS resources, and the terminal device adopts the same antenna port to send the SRSs on the multiple SRS resources according to the configuration of the network device. That is to say, the terminal device adopts the same antenna port to transmit SRSs on different SRS resources, and the network device may assume that the identical precoding matrixes/beams are used for sending SRSs on different SRS resources.

Exemplarily, the SRSs on the multiple SRS resources adopting the same transmission mode may be that the SRSs on the multiple SRS resources adopt the same transmit power, the same transmitting beam, and the same number of antenna ports.

Exemplarily, the SRSs on the multiple SRS resources adopting the same transmission mode may be that the SRSs on the multiple SRS resources adopt the same transmit power, the same transmitting beam, and the same antenna port.

The above examples are only for illustration purposes, and the technical solution of embodiments of the disclosure may also have other combinations.

In some implementations, in case where the network device configures multiple SRS resource sets, the SRSs on the multiple SRS resource sets adopting the same transmission mode includes at least one of the following cases.

1. The SRSs on the multiple SRS resource sets adopt the same transmit power.

Here, the network device configures the same power control parameter for the multiple SRS resource sets, and the terminal device adopts the same transmit power to send the SRSs on the multiple SRS resource sets according to the configuration of the network device.

2. The SRSs on the multiple SRS resource sets adopt the same transmitting beam (which may also be described as a spatial transmission filter).

Here, the network device configures the same spatial related parameter (or referred to as spatial related information) or the same TCI state for SRS resources in the multiple SRS resource sets, and the terminal device adopts the same transmitting beam (which may also be described as the spatial transmission filter) to send the SRSs on the multiple SRS resource sets according to the configuration of the network device. In an example, the network device may also configure the same associated CSI-RS for SRS resources in the multiple SRS resource sets, so that the terminal device may determine the same precoding matrix and transmitting beam (which may also be described as the spatial transmission filter) for SRS resources in the SRS resource sets according to the same associated CSI-RS.

3. The SRSs on the multiple SRS resource sets adopt the same number of antenna ports.

Here, the network device configures the same number of antenna ports for SRS resources in the multiple SRS resource sets, and the terminal device adopts the same number of antenna ports to send the SRSs on the multiple SRS resource sets according to the configuration of the network device.

4. The SRSs on the multiple SRS resource sets adopt the same antenna port.

Here, the network device configures the same antenna port for SRS resources in the multiple SRS resource sets, and the terminal device adopts the same antenna port to send the SRSs on the multiple SRS resource sets according to the configuration of the network device. That is to say, the terminal device adopts the same antenna port to transmit SRSs on different SRS resource sets, and the network device may assume that the identical precoding matrixes/beams are used for sending SRSs on different SRS resource sets.

Exemplarily, the SRSs on the multiple SRS resource sets adopting the same transmission mode may be that the SRSs on the multiple SRS resource sets adopt the same transmit power, the same transmitting beam, and the same number of antenna ports.

Exemplarily, the SRSs on the multiple SRS resource sets adopting the same transmission mode may be that the SRSs on the multiple SRS resource sets adopt the same transmit power, the same transmitting beam, and the same antenna port.

The above examples are only for illustration purposes, and the technical solution of embodiments of the disclosure may also have other combinations.

The same transmission resource is explained below.

The SRSs on the multiple SRS resource sets adopting the same transmission resource includes at least one of the following cases.

1. The SRSs on the multiple SRS resource sets adopt the same OFDM symbol index.

Here, the network device configures the same OFDM symbol index for SRS resources in the multiple SRS resource sets. Exemplarily, the network device may configure the same symbol starting position and the same number of OFDM symbols to configure the same OFDM symbol index. The terminal device adopts the same OFDM symbol index to send SRSs on the multiple SRS resource sets according to the configuration of the network device.

2. The SRSs on the multiple SRS resource sets adopt the same frequency domain resource.

Here, the network device configures the same frequency domain resource for SRS resources in the multiple SRS resource sets. Exemplarily, the network device may configure the same frequency band, the same PRB, the same comb structure, the same comb offset, etc. to configure the same frequency domain resource. The terminal device adopts the same frequency domain resource to send SRSs on the multiple SRS resource sets according to the configuration of the network device.

3. The SRSs on the multiple SRS resource sets adopt the same frequency hopping configuration.

Here, the network device configures the same frequency hopping parameter for SRS resources in the multiple SRS resource sets. The terminal device adopts the same frequency hopping configuration to send the SRSs on the multiple SRS resource sets according to the configuration of the network device.

Exemplarily, the SRSs on the multiple SRS resource sets adopting the same transmission resource may be that the SRSs on the multiple SRS resource sets adopt the same OFDM symbol index and the same frequency domain resource.

Exemplarily, the SRSs on the multiple SRS resource sets adopting the same transmission resource may be that the SRSs on the multiple SRS resource sets adopt the same OFDM symbol index, the same frequency domain resource, and the same frequency hopping configuration.

In the technical solution of embodiments of the disclosure, when the SRSs on the multiple SRS resource sets adopt the same transmission mode and transmission resource, the network device may perform accurate DLchannelPrediction according to the SRSs and obtain the downlink channel state information (such as precoding matrix) at a certain future moment. If the transmission modes or transmission resources are different, the accuracy of channel prediction will seriously deteriorate.

The same usage is explained below.

In some implementations, the multiple SRS resource sets are configured for the same usage.

In some implementations, the network device configures the multiple SRS resources sets for the same usage through high-level signaling.

Exemplarily, the usage of the above multiple SRS resource sets is configured to be “antennaSwitching”, that is, each SRS resource set supports xTyR antenna Switching. The network device may obtain complete uplink channel state information based on each SRS resource set, and perform downlink channel state information prediction according to channel reciprocity based on the multiple SRS resource sets.

Exemplarily, for the above multiple SRS resource sets, the network device may define a new usage that is distinguished from the usage configurations supported in the existing protocols. For example, the usage of the multiple SRS resource sets may be configured to be “channel prediction” or “DLchannelPrediction”.

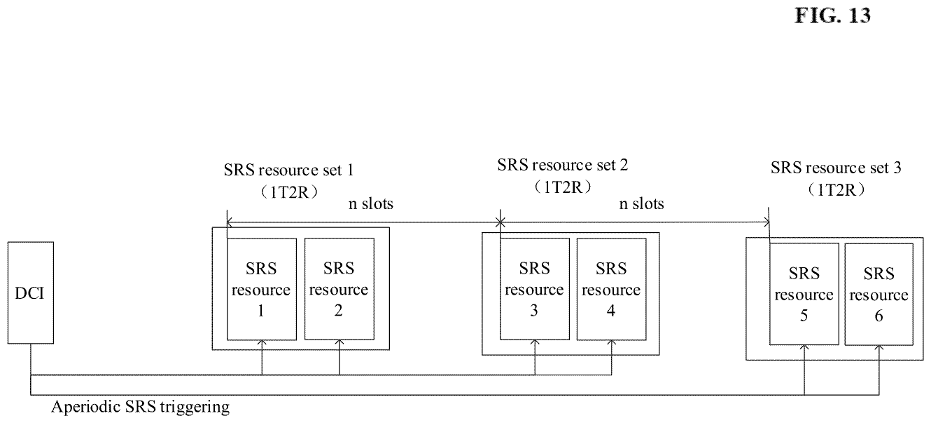

In some implementations, the multiple SRS resource sets are aperiodic SRS resource sets triggered by the same DCI. That is to say, the SRS resource sets correspond to the same aperiodic trigger state. Exemplarily, as shown in FIG. 13, 3 SRS resources are aperiodic SRS resource sets triggered by one piece of DCI, and each SRS resource set supports antenna Switching with 1 transmitter and 2 receivers (1T2R). In this case, SRSs sent on aperiodic SRS resource sets triggered by one piece of DCI have the phase consistency.

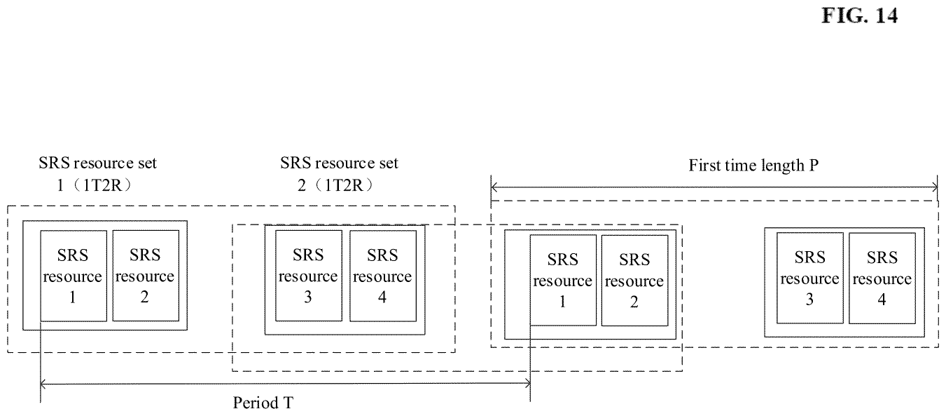

In some implementations, the multiple SRS resource sets are semi-persistent SRS resource sets or periodic SRS resource sets with the same period. As shown in FIG. 14, 2 SRS resource sets are both periodic SRS resource sets with a period of T.

In some implementations, the multiple SRS resource sets are separated by the same number of symbols or the same number of slots in the time domain. Here, the same number of slots may be obtained by configuring a trigger slot offset of SRS resource sets through the network device. For example, there may be n slots between multiple SRS resource sets as shown in FIG. 13. That is to say, in FIG. 13, the slot offsets of the 3 SRS resource sets triggered by the DCI are j, n+j, and 2n+j.

In the above example, the value of n may be indicated by the network device to the terminal device, and a value range of n may be predetermined. For example, the value range of n may be 1 and 2, where 1 represents adjacent slots and 2 represents that an interval is one slot.

The phase consistency is explained below.

In some implementations, the SRSs sent on the above multiple SRS resource sets have the phase consistency, and the phase consistency may also be replaced with other descriptions of same essence. Exemplarily, the following descriptions may be used for replacement.

The first alternative description is that the SRSs sent on the multiple SRS resource sets are coherent.

The second alternative description is that the relative phase change of the SRSs sent on the multiple SRS resource sets is within a certain range.

The third alternative description is that during the sending of the SRSs on the multiple SRS resource sets, the relative phase change of the transmitting antenna of the terminal device is within a certain range.

That is to say, the network device may assume that the SRSs sent on the multiple SRS resource sets are sent through the same antenna port.

Exemplarily, if the sequence of SRSs sent on a first SRS resource set (which may contain one or more SRS resources) is identical to the sequence of SRSs sent on a second SRS resource set (which may contain one or more SRS resources), and the relative phase changes of the SRSs are within a certain range, the SRSs can be regarded to have the phase consistency or be coherent.

It should be noted that the relative phase change may also be understood as a change in a phase difference. The relative phase change refers a relative phase change of the SRSs sent by the terminal device on the multiple SRS resource sets.

In some implementations, the metric (or requirement) of the above phase consistency mentioned above may be defined by the protocol or configured by the network device. The metric of the phase consistency may be defined by a threshold p, or defined by a duration t and the threshold p.

Exemplarily, if the relative phase change does not exceed the threshold p, the metric of the phase consistency is satisfied; otherwise, the metric of the phase consistency is not satisfied.

Exemplarily, if the relative phase change does not exceed the threshold p within the duration t, the metric of the phase consistency is satisfied; otherwise, the metric of the phase consistency is not satisfied. For example, if the relative phase change of the signal sent by the transmitting antenna of the terminal device within the duration t does not exceed the threshold value p, the signal satisfies the metric of the phase consistency, and thus the signal has the phase consistency; otherwise, the signal does not have the phase consistency.

In the technical solution of embodiments of the disclosure, if the SRSs sent on the multiple SRS resource sets have the phase consistency, the network device may perform accurate channel prediction according to the SRSs and obtain the channel state information at a certain future moment; otherwise, if the SRSs do not have the phase consistency, the accuracy of channel prediction will seriously deteriorate.

In some implementations, the terminal device reports a maximum time length in which the terminal device can maintain the phase consistency to the network device. The terminal device does not expect that a total duration of the multiple SRS resource sets exceeds the maximum time length in which the phase consistency is maintained reported by the terminal device. The restriction applies at least to the cases where the multiple SRS resource sets are aperiodic SRS resource sets, that is to say, the time length of a single SRS transmission triggered by the DCI does not exceed the maximum time length in which the terminal device can maintain the phase consistency.

In some implementations, if the maximum time length reported by the terminal device to the network device is a specific value, such as 1, it indicates that the terminal device does not support the phase consistency. In this case, the network device will not or cannot configure the above multiple SRS resource sets for DLchannelPrediction to the terminal device.

Exemplarily, the above maximum time length may be in units of slots, symbols (such as OFDM symbols), or ms.

In some implementations, the terminal device receives a first time length indicated by the network device. Exemplarily, the network device may indicate the first time length through high-level signaling (such as the RRC signaling) or DCI. The SRSs sent by the terminal device on the multiple SRS resource sets within the first time length need to maintain the phase consistency. This solution may at least be applied to the cases where the multiple SRS resource sets are periodic or semi-persistent SRS resource sets.

Exemplarily, the first time length mentioned above may be in units of slots, symbols (such as OFDM symbols), or ms.

In some implementations, the first time length is less than or equal to the maximum time length in which the phase consistency is maintained reported by the terminal device.

In some implementations, the SRSs sent by the terminal device on the multiple SRS resource sets within any time window with the first time length maintain the phase consistency. Exemplarily, as shown in FIG. 14, the first time length is P, and the terminal device needs to ensure that the SRSs sent on the SRS resource sets have the phase consistency within any time window (the time windows indicated by the dashed boxes) with the length P. In FIG. 14, 2 SRS resource sets are both semi-persistent SRS resource sets or periodic SRS resource sets with a period of T.

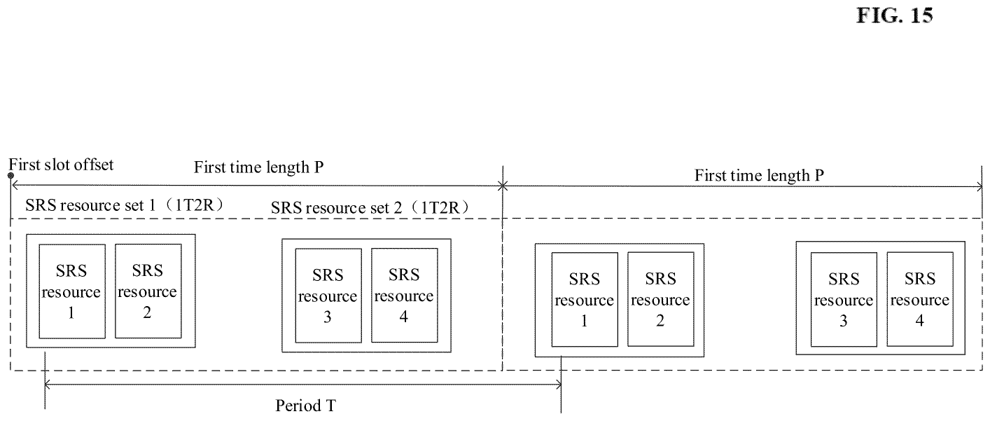

In other implementations, the SRSs sent by the terminal device on the multiple SRS resource sets within each time window with the first time length starting from a first time domain offset maintain the phase consistency. Herein, the first time domain offset may be indicated by the network device to the terminal device. The first time domain offset may be either a slot offset or a symbol offset, which indicates the starting point of the first time window. The SRSs sent within the first time window and each subsequent time window maintain the phase consistency. The SRSs within each time window with the length P have the phase consistency, and each time window with the length P is the time window in which the network device performs DLchannelPrediction. Exemplarily, as shown in FIG. 15, the first time length is P. The starting point of the first time window is determined based on the first time domain offset. The terminal device needs to ensure that the SRSs sent on the SRS resource sets have the phase consistency within each time window (the time windows indicated by the dashed boxes) with the length P. In FIG. 15, 2 SRS resource sets are both semi-persistent SRS resource sets or periodic SRS resource sets with a period of T.

In the technical solution of embodiments of the disclosure, the network device indicates the first time length less than or equal to the maximum time length in which the phase consistency is maintained reported by the terminal device, thereby effectively reducing the implementation complexity of the terminal device. The terminal device only needs to ensure that the SRSs have the phase consistency within a relatively short time window (i.e., the measurement time window of the network device).

At 1204, the network device receives the SRSs sent by the terminal device on the multiple SRS resource sets.

At 1205, the network device performs downlink channel state information prediction according to received SRSs.

Here, the network device may obtain the downlink channel state information based on the uplink channel state information measured on the SRS resource sets based on the channel reciprocity.

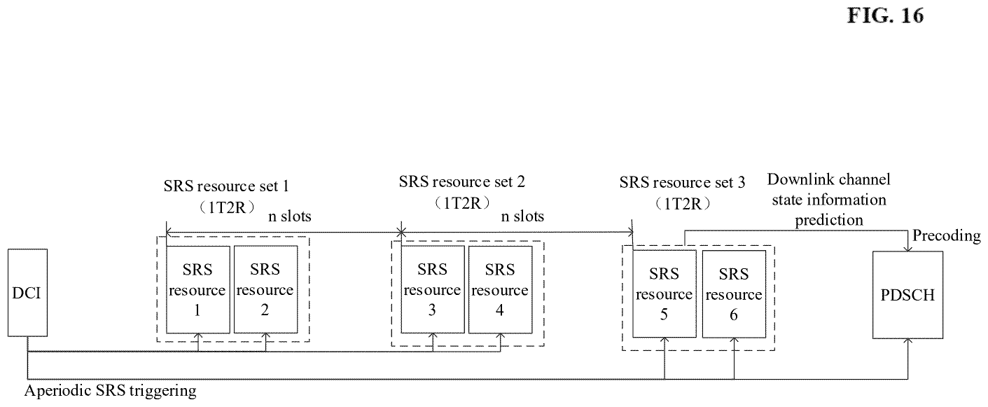

In some implementations, the network device measures the uplink channel state information according to several SRSs separated by equal intervals in the time domain on each SRS resource set. The network device obtains the downlink channel state information based on the channel reciprocity according to the uplink channel state information. The network device predicts downlink channel state information (such as the downlink precoding matrix) after k slots based on the measured downlink channel information at several moments. The network device uses the predicted downlink channel state information to transmit the PDSCH after Y slots, thereby avoiding performance loss caused by the delay of the downlink channel state information. Exemplarily, as shown in FIG. 16, 3 SRS resource sets are separated by n slots in the time domain. The 3 SRS resource sets are aperiodic SRS resource sets triggered by the same piece of DCI. The SRSs sent by the terminal device on the 3 SRS resource sets adopt the same transmission mode and the same transmission resource, and have the phase consistency. The network device may receive the SRSs on the 3 SRS resource sets, predict the downlink channel state information after Y (Y≥1) slots according to the received SRSs, and transmit the PDSCH after Y slots according to the downlink channel state information. Here, one piece of DCI is used to schedule the PDSCH and trigger multiple SRS resource sets, thereby saving the overhead of downlink control signaling. Third application example

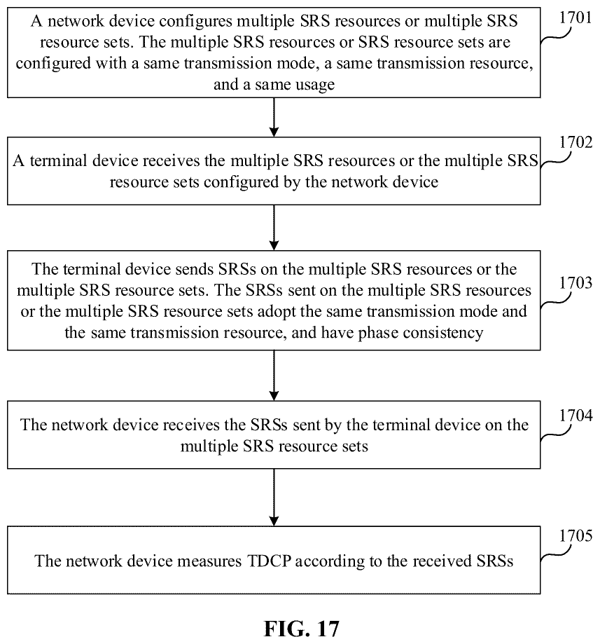

In this application example, SRSs on multiple SRS resources or SRS resource sets are used for TDCP measurement, as shown in FIG. 17. This application example includes one or more of the following operations.

At 1701, a network device configures multiple SRS resources or multiple SRS resource sets. The multiple SRS resources or SRS resource sets are configured with a same transmission mode, a same transmission resource, and a same usage.

At 1702, a terminal device receives the multiple SRS resources or the multiple SRS resource sets configured by the network device.

At 1703, the terminal device sends SRSs on the multiple SRS resources or the multiple SRS resource sets. The SRSs sent on the multiple SRS resources or the multiple SRS resource sets adopt the same transmission mode and the same transmission resource, and have phase consistency.

The same transmission mode is explained below.

In some implementations, in case where the network device configures multiple SRS resources, the SRSs on the multiple SRS resources adopting the same transmission mode includes at least one of the following cases.

1. The SRSs on the multiple SRS resources adopt the same transmit power.

Here, the network device configures the same power control parameter for the multiple SRS resources, and the terminal device adopts the same transmit power to send the SRSs on the multiple SRS resources according to the configuration of the network device.

2. The SRSs on the multiple SRS resources adopt the same transmitting beam (which may also be described as a spatial transmission filter).

Here, the network device configures the same spatial related parameter (or referred to as spatial related information) or the same TCI state for the multiple SRS resources, and the terminal device adopts the same transmitting beam (which may also be described as the spatial transmission filter) to send the SRSs on the multiple SRS resources according to the configuration of the network device.

3. The SRSs on the multiple SRS resources adopt the same number of antenna ports.

Here, the network device configures the same number of antenna ports for the multiple SRS resources, and the terminal device adopts the same number of antenna ports to send the SRSs on the multiple SRS resources according to the configuration of the network device.

Exemplarily, when the SRSs are used for TDCP measurement, the number of antenna ports for the multiple SRS resources may be fixed to be 1, thereby reducing SRS overhead.

4. The SRSs on the multiple SRS resources adopt the same antenna port.

Here, the network device configures the same antenna port for the multiple SRS resources, and the terminal device adopts the same antenna port to send the SRSs on the multiple SRS resources according to the configuration of the network device. That is to say, the terminal device adopts the same antenna port to transmit SRSs on different SRS resources, and the network device may assume that identical precoding matrix/beam are used for sending SRSs on different SRS resources.

Exemplarily, the SRSs on the multiple SRS resources adopting the same transmission mode may be that the SRSs on the multiple SRS resources adopt the same transmit power, the same transmitting beam, and the same number of antenna ports.

Exemplarily, the SRSs on the multiple SRS resources adopting the same transmission mode may be that the SRSs on the multiple SRS resources adopt the same transmit power, the same transmitting beam, and the same antenna port.

The above examples are only for illustration purposes, and the technical solution of embodiments of the disclosure may also have other combinations.

In some implementations, in case where the network device configures multiple SRS resource sets, the SRSs on the multiple SRS resource sets adopting the same transmission mode includes at least one of the following cases.

1. The SRSs on the multiple SRS resource sets adopt the same transmit power.

Here, the network device configures the same power control parameter for the multiple SRS resource sets, and the terminal device adopts the same transmit power to send the SRSs on the multiple SRS resource sets according to the configuration of the network device.

2. The SRSs on the multiple SRS resource sets adopt the same transmitting beam (which may also be described as a spatial transmission filter).

Here, the network device configures the same spatial related parameter (or referred to as spatial related information) or the same TCI state for SRS resources in the multiple SRS resource sets, and the terminal device adopts the same transmitting beam (which may also be described as the spatial transmission filter) to send the SRSs on the multiple SRS resource sets according to the configuration of the network device. In an example, the network device may also configure the same associated CSI-RS for SRS resources in the multiple SRS resource sets, so that the terminal device may determine the same precoding matrix and the same transmitting beam (which may also be described as the spatial transmission filter) for SRS resources in the SRS resource set according to the same associated CSI-RS.

3. The SRSs on the multiple SRS resource sets adopt the same number of antenna ports.

Here, the network device configures the same number of antenna ports for SRS resources in the multiple SRS resource sets, and the terminal device adopts the same number of antenna ports to send the SRSs on the multiple SRS resource sets according to the configuration of the network device.

Exemplarily, when the SRSs are used for TDCP measurement, the number of antenna ports for the multiple SRS resource sets may be fixed to be 1, thereby reducing SRS overhead.

4. The SRSs on the multiple SRS resource sets adopt the same antenna port.

Here, the network device configures the same antenna port for SRS resources in the multiple SRS resource sets, and the terminal device adopts the same antenna port to send SRSs on the multiple SRS resource sets according to the configuration of the network device. That is to say, the terminal device adopts the same antenna port to transmit SRSs on different SRS resource sets, and the network device may assume that identical precoding matrixes/beams are used for sending SRSs on different SRS resource sets.

Exemplarily, the SRSs on the multiple SRS resource sets adopting the same transmission mode may be that the SRSs on the multiple SRS resource sets adopt the same transmit power, the same transmitting beam, and the same number of antenna ports.

Exemplarily, the SRSs on the multiple SRS resource sets adopting the same transmission mode may be that the SRSs on the multiple SRS resource sets adopt the same transmit power, the same transmitting beam, and the same antenna port.

The above examples are only for illustration purposes, and the technical solution of embodiments of the disclosure may also have other combinations.

The same transmission resource is explained below.

In some implementations, in case where the network device configures multiple SRS resources, the SRSs on the multiple SRS resources adopting the same transmission resource includes at least one of the following cases.

1. The SRSs on the multiple SRS resources adopt the same OFDM symbol index.

Here, the network device configures the same OFDM symbol index for the multiple SRS resources. Exemplarily, the network device may configure the same symbol starting position and the same number of OFDM symbols for the multiple SRS resources to configure the same OFDM symbol index. The terminal device adopts the same OFDM symbol index to send the SRSs on the multiple SRS resources according to the configuration of the network device.

2. The SRSs on the multiple SRS resources adopt the same frequency domain resource.

Here, the network device configures the same frequency domain resource for the multiple SRS resources. Exemplarily, the network device may configure the same frequency band, the same PRB, the same comb structure, the same comb offset, etc. for the multiple SRS resources to configure the same frequency domain resource. The terminal device adopts the same frequency domain resource to send the SRSs on the multiple SRS resources according to the configuration of the network device.

3. The SRSs on the multiple SRS resources adopt the same frequency hopping configuration.

Here, the network device configures the same frequency hopping parameter for the multiple SRS resources. The terminal device adopts the same frequency hopping configuration to send the SRSs on the multiple SRS resources according to the configuration of the network device.

4. The SRSs on the multiple SRS resources adopt the same cyclic shift.

Here, the network device configures the same cyclic shift for the multiple SRS resources. The terminal device adopts the same cyclic shift to send the SRSs on the multiple SRS resources according to the configuration of the network device.

5. The SRSs on the multiple SRS resources adopt the same SRS base sequence.

Here, the network device configures the same SRS base sequence for the multiple SRS resources. The network device may configure the same SRS base sequence ID for the multiple SRS resources.

The terminal device adopts the same SRS sequence to send the SRSs on the multiple SRS resources according to the configuration of the network device.

Exemplarily, the SRSs on the multiple SRS resources adopting the same transmission resource may be that the SRSs on the multiple SRS resources adopt the same OFDM symbol index, the same frequency domain resource, and the same SRS sequence (the same SRS base sequence and the same cyclic shift).

Exemplarily, the SRSs on the multiple SRS resources adopting the same transmission resource may be that the SRSs on the multiple SRS resources adopt the same OFDM symbol index, the same frequency domain resource, the same frequency hopping configuration, and the same SRS sequence (the same SRS base sequence and the same cyclic shift).

The above examples are only for illustration purposes, and the technical solution of embodiments of the disclosure may also have other combinations.

In some implementations, in case where the network device configures multiple SRS resource sets, the SRSs on the multiple SRS resource sets adopting the same transmission resource includes at least one of the following cases.

1. The SRSs on the multiple SRS resource sets adopt the same OFDM symbol index.

Here, the network device configures the same OFDM symbol index for SRS resources in the multiple SRS resource sets. Exemplarily, the network device may configure the same symbol starting position and the same number of OFDM symbols to configure the same OFDM symbol index. The terminal device adopts the same OFDM symbol index to send the SRSs on the multiple SRS resource sets according to the configuration of the network device.

2. The SRSs on the multiple SRS resource sets adopt the same frequency domain resource.

Here, the network device configures the same frequency domain resource for SRS resources in the multiple SRS resource sets. Exemplarily, the network device may configure the same frequency band, the same PRB, the same comb structure, the same comb offset, etc. to configure the same frequency domain resource. The terminal device adopts the same frequency domain resource to send the SRSs on the multiple SRS resource sets according to the configuration of the network device.

3. The SRSs on the multiple SRS resource sets adopt the same frequency hopping configuration.

Here, the network device configures the same frequency hopping parameter for SRS resources in the multiple SRS resource sets. The terminal device adopts the same frequency hopping configuration to send the SRSs on the multiple SRS resource sets according to the configuration of the network device.

4. The SRSs on the multiple SRS resource sets adopt the same cyclic shift.

Here, the network device configures the same cyclic shift for the multiple SRS resource sets. The terminal device adopts the same cyclic shift to send the SRSs on the multiple SRS resource sets according to the configuration of the network device.

5. The SRSs on the multiple SRS resource sets adopt the same SRS base sequence.

Here, the network device configures the same SRS base sequence for the multiple SRS resource sets. The network device may configure the same SRS base sequence ID for the multiple SRS resource sets.

The terminal device adopts the same SRS sequence to send the SRSs on the multiple SRS resource sets according to the configuration of the network device.

Exemplarily, the SRSs on the multiple SRS resource sets adopting the same transmission resource may be that the SRSs on the multiple SRS resource sets adopt the same OFDM symbol index, the same frequency domain resource, and the same SRS sequence (the same SRS base sequence and the same cyclic shift).

Exemplarily, the SRSs on the multiple SRS resource sets adopting the same transmission resource may be that the SRSs on the multiple SRS resource sets adopt the same OFDM symbol index, the same frequency domain resource, the same frequency hopping configuration, and the same SRS sequence (the same SRS base sequence and the same cyclic shift).

The above examples are only for illustration purposes, and the technical solution of embodiments of the disclosure may also have other combinations.

In the technical solution of embodiments of the disclosure, when the SRSs on the multiple SRS resources or the multiple SRS resource sets adopt the same transmission mode and transmission resource, the network device may perform TDCP measurement according to the SRSs. If the transmission modes or transmission resources are different, the network device cannot accurate perform the TDCP measurement. In another aspect, if identical SRS sequences are used by the multiple SRS resources or the multiple SRS resource sets, the network device may directly perform the TDCP measurement based on the received SRSs without performing channel estimation, thereby reducing implementation complexity.

The same usage is explained below.

In some implementations, the multiple SRS resources or multiple SRS resource sets are configured by the network device for a same usage.

In some implementations, the network device configures the multiple SRS resources or the multiple SRS resource sets for the same usage through high-level signaling.

Exemplarily, the network device may define a new usage for the above multiple SRS resources or the above multiple SRS resource sets, and the new usage is distinguished from the usage configurations supported in the existing protocols. For example, the usage of the multiple SRS resources or the multiple SRS resource sets may be configured to be “TDCP measurement” or “TDCP”.

In some implementations, the multiple SRS resources or the multiple SRS resource sets are aperiodic SRS resources or aperiodic SRS resource sets triggered by the same piece of DCI. That is to say, the SRS resources or SRS resource sets correspond to the same aperiodic trigger state. Exemplarily, as shown in FIGS. 6 and 8, 4 SRS resources are aperiodic SRS resources triggered by one piece of DCI in FIGS. 6, and 3 SRS resource sets are aperiodic SRS resource sets triggered by the same piece of DCI in FIG. 8. At this point, SRSs sent on aperiodic SRS resources or SRS resource sets triggered by one piece of DCI have phase consistency.

In other implementations, the multiple SRS resources are semi-persistent SRS resources or periodic SRS resources with the same period, or the multiple SRS resource sets are semi-persistent SRS resource sets or periodic SRS resource sets with the same period. As shown in FIG. 7, all 3 SRS resources are periodic SRS resources with a period of T.

In some implementations, the multiple SRS resources or the multiple SRS resource sets are separated by the same number of symbols or the same number of slots in the time domain. Here, the same number of slots may be obtained by configuring the slot offset of SRS resources or configuring the trigger slot offset of SRS resource sets through the network device. For example, multiple SRS resources may be separated by k symbols, as shown in FIG. 6. For example, multiple SRS resources may be separated by m slots, as shown in FIG. 7. For example, multiple SRS resource sets may be separated by n slots, as shown in FIG. 8. That is to say, in FIG. 8, the slot offsets of the 3 SRS resource sets triggered by the DCI are j, n+j, and 2n+j.

In the above examples, the value of k/m/n may be indicated by the network device to the terminal device, and the value range thereof may be predetermined. For example, the value range of m and n may be 1 and 2, where 1 represents adjacent slots and 2 represents that an interval is one slot.

The phase consistency is explained below.

In some implementations, the SRSs sent on the above multiple SRS resources or the above multiple SRS resource sets have phase consistency, and the phase consistency may also be replaced with other descriptions of the same essence. Exemplarily, the following descriptions may be used for replacement.

The first alternative description is that the SRSs sent on the multiple SRS resources or the multiple SRS resource sets are coherent.

The second alternative description is that the relative phase change of the SRSs sent on the multiple SRS resources or the multiple SRS resource sets is within a certain range.

The third alternative description is that during the sending of the SRSs on the multiple SRS resources or the multiple SRS resource sets, the relative phase change of the transmitting antenna of the terminal device is within a certain range.

That is to say, the network device may assume that the SRSs sent on the multiple SRS resources or the multiple SRS resource sets are sent through the same antenna port.

Exemplarily, if the sequence of SRSs sent on a first SRS resource is identical to the sequence of SRSs sent on a second SRS resource, and the relative phase changes of the transmitting antennas of the SRSs are within a certain range, the SRSs can be regarded to have phase consistency or be coherent.

Exemplarily, if the sequence of SRSs sent on a first SRS resource set (which may contain one or more SRS resources) is identical to the sequence of SRSs sent on a second SRS resource set (which may contain one or more SRS resources), and the relative phase changes of the SRSs are within a certain range, the SRSs can be regarded to have the phase consistency or be coherent.

It should be noted that the relative phase change may also be understood as a change in a phase difference. The relative phase change refers a relative phase change of the SRSs sent by the terminal device on the multiple SRS resources or the multiple SRS resource sets.

In some implementations, the metric (or requirement) of the above phase consistency may be defined by the protocol or configured by the network device. The metric of the phase consistency may be defined by a threshold p, or defined by a duration t and the threshold p.

Exemplarily, the metric of the phase consistency may be that if the relative phase change does not exceed the threshold p, the metric of the phase consistency is satisfied; otherwise, the metric of the phase consistency is not satisfied.

Exemplarily, the metric of the phase consistency may be that if the relative phase change does not exceed the threshold p within the duration t, the metric of the phase consistency is satisfied; otherwise, the metric of the phase consistency is not satisfied. For example, if the relative phase change of the signal sent by the transmitting antenna of the terminal device within the duration t does not exceed the threshold value p, the signal satisfies the metric of the phase consistency, and thus the signal has the phase consistency; otherwise, the signal does not have the phase consistency.

In the technical solution of embodiments of the disclosure, if the SRSs sent on the multiple SRS resources or the multiple SRS resource sets have the phase consistency, the network device may perform the TDCP measurement according to the SRSs; otherwise, if the SRSs do not have the phase consistency, then a result of the TDCP measurement is unavailable because the phase change is unknown.

In some implementations, the terminal device reports a maximum time length in which the terminal device can maintain the phase consistency to the network device. The terminal device does not expect that a total duration of the multiple SRS resources or the multiple SRS resource sets exceeds the maximum time length in which the phase consistency is maintained reported by the terminal device. This restriction applies at least to the cases where the multiple SRS resources or the multiple SRS resource sets are aperiodic SRS resources or aperiodic SRS resource sets, that is to say, the time length of a single SRS transmission triggered by the DCI does not exceed the maximum time length in which the terminal device can maintain the phase consistency.

In some implementations, if the maximum time length reported by the terminal device to the network device is a specific value, such as 1, it indicates that the terminal device does not support the phase consistency. In this case, the network device will not or cannot configure the above multiple SRS resources or the above multiple SRS resource sets for TDCP measurement for the terminal device.

Exemplarily, the above maximum time length may be in units of slots, symbols (such as OFDM symbols), or ms.

In some implementations, the terminal device receives a first time length indicated by the network device. Exemplarily, the network device may indicate the first time length through high-level signaling (such as the RRC signaling) or DCI, and the first time length is the time window for TDCP measurement by the network device. The SRSs sent by the terminal device on the multiple SRS resources or the multiple SRS resource sets within the first time length maintain the phase consistency. This solution may at least be applied to the cases where the multiple SRS resources or SRS resource sets are periodic or semi-persistent SRS resources or periodic or semi-persistent SRS resource sets.

Exemplarily, the above first time length may be in units of slots, symbols (such as OFDM symbols), or ms.

In some implementations, the first time length is less than or equal to the maximum time length in which the phase consistency is maintained reported by the terminal device.

In the technical solution of embodiments of the disclosure, the network device indicates the first time length less than or equal to the maximum time length in which the phase consistency is maintained reported by the terminal device, thereby effectively reducing the implementation complexity of the terminal device. The terminal device only needs to ensure that the SRSs have the phase consistency within a relatively short time window (i.e., the TDCP measurement time window of the network device).

At 1704, the network device receives the SRSs sent by the terminal device on the multiple SRS resource sets.

At 1705, the network device performs TDCP measurement according to received SRSs.

In some implementations, the network device may perform uplink and downlink parameter configuration based on the result of the TDCP measurement.

Exemplarily, the network device may determine channel state information reporting configuration and a CSI-RS resource configuration parameter based on the result of TDCP measurement.

Exemplarily, the network device may determine an SRS resource configuration parameter based on the result of the TDCP measurement.

Exemplarily, the network device may determine a precoding solution based on the result of the TDCP measurement, such as determining a precode matrix indication (PMI)-based feedback solution, or determining a channel reciprocity-based feedback solution, or determining the type of codebook used.

Fourth application example

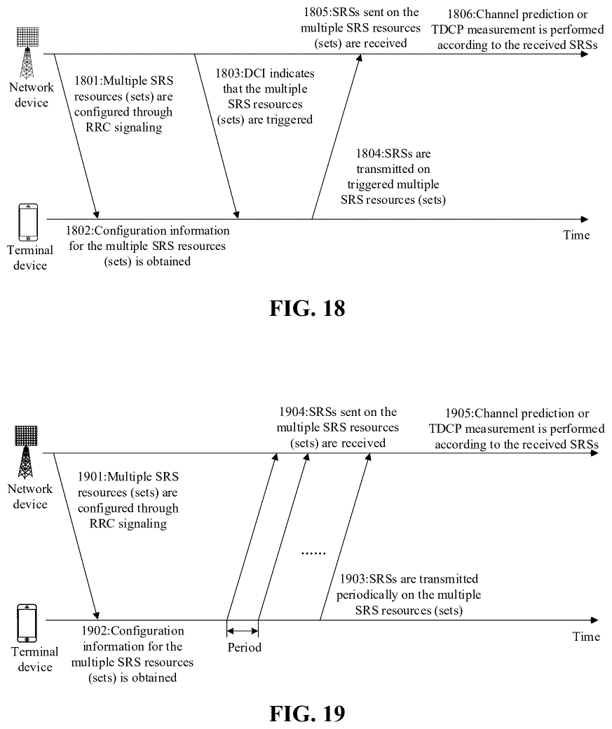

In this application example, SRS resources (sets) represent SRS resources or SRS resource sets, and SRS resources (sets) in multiple SRS resources (sets) are aperiodic SRS resources (sets) triggered by the same piece of DCI. As shown in FIG. 18, this application example includes one or more of the following operations.

At 1801, a network device configures multiple SRS resources (sets) for a terminal device through RRC signaling. The multiple SRS resources (sets) are configured with a same transmission mode, a same transmission resource, and a same usage.

Here, regarding the specific implementation of the same transmission mode, the same transmission resource, and the same usage, reference may be made to the above relevant solutions.

At 1802, the terminal device obtains configuration information for the multiple SRS resources (sets) based on the RRC signaling.

Here, regarding the specific implementation of the configuration information for the multiple SRS resources (sets), reference may be made to the above relevant solutions. It should be pointed out that the type of each SRS resource (set) is configured in the configuration information of the SRS resource (set), and the type indicates aperiodicity.

At 1803, the network device indicates that multiple SRS resources (sets) are triggered through DCI.

Here, regarding the format of the DCI and the mode of indicating the triggered multiple SRS resources (sets), reference may be made to the relevant solutions mentioned above.

At 1804, the terminal device determines triggered multiple SRS resources (sets) based on the DCI and transmits SRSs on the triggered multiple SRS resources (sets).

Here, after receiving the DCI and determining the triggered multiple SRS resources (sets), the terminal device determines that the multiple SRS resources (sets) have the same usage based on the configuration information (obtained through operation 1802) of the multiple SRS resources (sets). In case where it is determined that the multiple SRS resources (sets) have the same usage, the same transmission mode and the same transmission resource are adopted for transmitting SRSs on the triggered multiple SRS resources (sets), and the SRSs transmitted on the multiple SRS resources (sets) have the phase consistency.

Here, there is a slot offset between SRS transmissions on the multiple SRS resources (sets) and the DCI, and the slot offset may be configured by high-level signaling (such as the RRC signaling). For example, if the terminal device receives the DCI in slot n, the terminal device sends SRSs on the SRS resources (sets) in slot

$$⌊ n \cdot \frac{{2}^{{μ}_{SRS}}}{{2}^{{μ}_{PDCCH}}} ⌋ + k ,$$

where k is indicated by a parameter slot offset configured for the SRS resources (sets), and μ_{SRS} and μ_{PDCCH} are a subcarrier spacing configuration of the SRS resources (sets) triggered by the DCI and a subcarrier spacing configuration of the PDCCH where DCI is located, respectively.

At 1805, the network device receives the SRSs sent by the terminal device on the multiple SRS resources (sets).

At 1806, the network device performs channel prediction or TDCP measurement according to received SRSs.

Here, in operation 1801, the network device configures multiple SRS resources (sets) for the same usage, and the usage depends on the implementation of the network device, and may be ULchannelPrediction, DLchannelPrediction, or TDCP measurement. The network device performs an operation corresponding to the usage according to the received SRSs.

As an implementation, if the usage is ULchannelPrediction, the network device performs ULchannelPrediction according to the received SRSs. As another implementation, if the usage is DLchannelPrediction, the network device performs DLchannelPrediction according to the received SRSs. As still another implementation, if the usage is TDCP measurement, the network device performs TDCP measurement according to the received SRSs.

Here, regarding the specific implementation of ULchannelPrediction, reference may be made to the relevant solution of the above first application example. Regarding the specific implementation of DLchannelPrediction, reference may be made to the relevant solution of the above second application example. Regarding the specific implementation of TDCP measurement, reference may be made to the relevant solution of the above third application example.

Fifth application example

In this application example, SRS resources (sets) represent SRS resources or SRS resource sets, and SRS resources (sets) in multiple SRS resources (sets) are periodic SRS resources with the same period. As shown in FIG. 19, this application example includes one or more of the following operations.

At 1901, a network device configures multiple SRS resources (sets) for a terminal device through RRC signaling. The multiple SRS resources (sets) are configured with a same period, a same transmission mode, a same transmission resource, and a same usage.

Here, regarding the specific implementation of the same transmission mode, the same transmission resource, and the same usage, reference may be made to the above relevant solutions.

At 1902, the terminal device obtains configuration information for the multiple SRS resources (sets) based on the RRC signaling.

Here, regarding the specific implementation of the configuration information for the multiple SRS resources (sets), reference may be made to the above relevant solutions. It should be pointed out that the type of each SRS resource (set) is configured in the configuration information of the SRS resource (set), and the type indicates periodicity.

At 1903, the terminal device periodically transmits SRSs on the multiple SRS resources (sets) according to the configuration information until the configuration information becomes invalid.

Here, the RRC signaling configures the period and slot offset of each SRS resource (set). The multiple SRS resources (sets) have the same period, but different slot offsets. Once the terminal device receives the configuration information for the multiple SRS resources (sets), the terminal device periodically transmits the SRSs on the multiple SRS resources (sets) according to the configuration information until the configuration information becomes invalid.

At 1904, the network device receives SRSs sent by the terminal device on the multiple SRS resources (sets).

At 1905, the network device performs channel prediction or TDCP measurement according to received SRSs.

Here, in operation 1901, the network device configures multiple SRS resources (sets) for the same usage, and the usage depends on the implementation of the network device, and may be ULchannelPrediction, DLchannelPrediction, or TDCP measurement. The network device performs an operation corresponding to the usage according to the received SRSs.

As an implementation, if the usage is ULchannelPrediction, the network device performs ULchannelPrediction according to the received SRSs. As another implementation, if the usage is DLchannelPrediction, the network device performs DLchannelPrediction according to the received SRSs. As still another implementation, if the usage is TDCP measurement, the network device performs TDCP measurement according to the received SRSs.

Here, regarding the specific implementation of ULchannelPrediction, reference may be made to the relevant solution of the above first application example. Regarding the specific implementation of DLchannelPrediction, reference may be made to the relevant solution of the above second application example. Regarding the specific implementation of TDCP measurement, reference may be made to the relevant solution of the above third application example.

Sixth application example

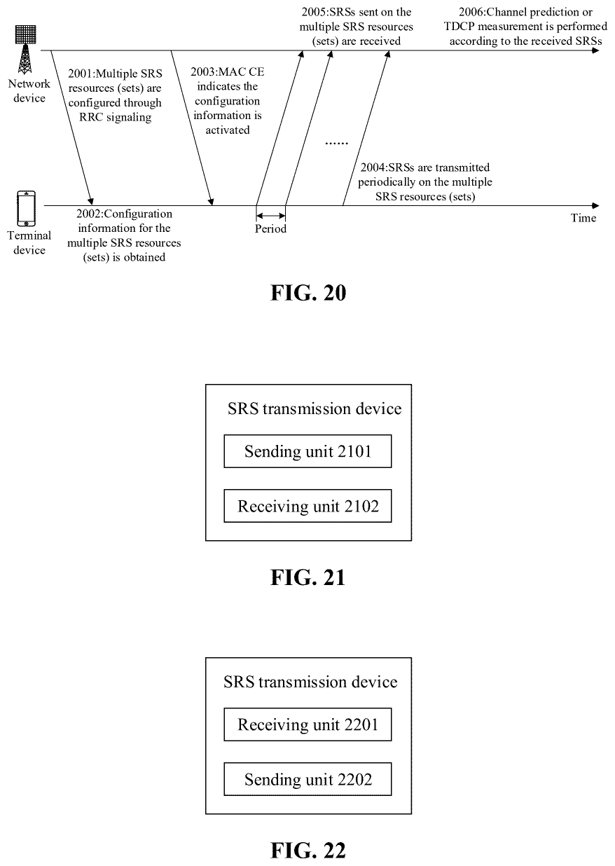

In this application example, SRS resources (sets) represent SRS resources or SRS resource sets, and SRS resources (sets) in multiple SRS resources (sets) are semi-persistent SRS resources with the same period. As shown in FIG. 20, this application example includes one or more of the following operations.

At 2001, a network device configures multiple SRS resources (sets) for a terminal device through RRC signaling. The multiple SRS resources (sets) are configured with a same period, a same transmission mode, a same transmission resource, and a same usage.

Here, regarding the specific implementation of the same transmission mode, the same transmission resource, and the same usage, reference may be made to the above relevant solutions.

At 2002, the terminal device obtains configuration information for the multiple SRS resources (sets) based on the RRC signaling.

Here, regarding the specific implementation of the configuration information for the multiple SRS resources (sets), reference may be made to the above relevant solutions. It should be pointed out that the type of each SRS resource (set) is configured in the configuration information of the SRS resource (set), where the type indicates semi-persistent.

At 2003, the network device indicates to activate the above configuration information through MAC CE.

At 2004, the terminal device periodically transmits SRSs on the multiple SRS resources (sets) according to the above configuration information until the MAC CE indicating to deactivate the above configuration information is received.

Here, the RRC signaling configures the period and the slot offset of each SRS resource (set). The multiple SRS resources (sets) have the same period, but differences slot offsets. After receiving configuration information for multiple SRS resources (sets), the terminal device waits for the MAC CE indicating to activate the above configuration information. Once the terminal device receives the MAC CE indicating to activate the above configuration information, the terminal device periodically transmits the SRSs on the multiple SRS resources (sets) according to the configuration information until the MAC CE indicating to deactivate the above configuration information is received.

At 2005, the network device receives the SRSs sent by the terminal device on the multiple SRS resources (sets).

At 2006, the network device performs channel prediction or TDCP measurement according to received SRSs.

Here, in operation 2001, the network device configures multiple SRS resources (sets) for the same usage, and the usage depends on the implementation of the network device, and may be ULchannelPrediction, DLchannelPrediction, or TDCP measurement. The network device performs an operation corresponding to the usage according to the received SRSs.

As an implementation, if the usage is ULchannelPrediction, the network device performs ULchannelPrediction according to the received SRSs. As another implementation, if the usage is DLchannelPrediction, the network device performs DLchannelPrediction according to the received SRSs. As still another implementation, if the usage is TDCP measurement, the network device performs TDCP measurement according to the received SRSs.

Here, regarding the specific implementation of ULchannelPrediction, reference may be made to the relevant solution of the above first application example. Regarding the specific implementation of DLchannelPrediction, reference may be made to the relevant solution of the above second application example. Regarding the specific implementation of TDCP measurement, reference may be made to the relevant solution of the above third application example.

Preferred implementations of the disclosure are described in detail in conjunction with accompanying drawings. However, the disclosure is not limited to the particular details in the above implementations. Within the range of the technical idea of the disclosure, multiple simple variations can be made to the technical solutions of the disclosure, and these variations all fall within the scope of protection of the disclosure. For example, the particular technical features described in the above particular implementations may be combined in any suitable way without conflict. To avoid unnecessary repetition, the possible combinations are not described in the disclosure. For another example, different implementations of the disclosure may also be combined arbitrarily without departing from the concept of the disclosure, which shall be considered as content disclosed by the disclosure as well. For another example, without conflict, the various embodiments described in the disclosure and/or technical features of the various embodiments may be combined with the related art arbitrarily, and the technical solutions obtained via the combination shall also fall within the scope of protection of the disclosure.

It should also be understood that in various method embodiments of the disclosure, the sequence number of the above processes does not mean the order of execution, and the execution order of each process should be determined according to its function and inherent logic, and should not constitute any limitation on the implementation of embodiments of the disclosure. Further, in embodiments of the disclosure, the terms “downlink”, “uplink” and “sidelink” are used to represent the transmission direction of the signal or data. Herein “downlink” is used to represent that the transmission direction of the signal or data is a first direction sent from a site to a user device of a cell, “uplink” is used to represent that the transmission direction of the signal or data is a second direction sent from the user device of the cell to the site, and “sidelink” is used to represent that the transmission direction of the signal or data is a third direction sent from a user device 1 to a user device 2. For example, “downlink signal” represents that the transmission direction of the signal is the first direction. In addition, in embodiments of the disclosure, the term “and/or” is only an association relationship describing associated objects and represents that three relationships may exist. Specifically, A and/or B may represent three conditions: independent existence of A, existence of both A and B, and independent existence of B. In addition, the character “/” herein generally indicates that the associated objects are in an “or” relationship.

FIG. 21 is a first schematic structural composition diagram of an SRS transmission device provided by an embodiment of the disclosure, which is applied to a terminal device. As shown in FIG. 21, the SRS transmission device includes a sending unit 2101.

The sending unit 2101 is configured to send SRSs on multiple SRS resources or multiple SRS resource sets. The SRSs on the multiple SRS resources or the multiple SRS resource sets adopt a same transmission mode and a same transmission resource, and have phase consistency.

In some implementations, the SRS transmission device further includes a receiving unit 2102, which is configured to receive first configuration information sent by a network device. The first configuration information is used for configuring the multiple SRS resources or the multiple SRS resource sets. The multiple SRS resources or the multiple SRS resource sets are configured with the same transmission mode, the same transmission resource, and the same usage.

In some implementations, the same transmission mode includes at least one of the following: the same transmit power; the same power control parameter; the same spatial related parameter; the same number of antenna ports; or the same antenna port.

In some implementations, the same transmission resource includes at least one of the following: the same symbol index; the same frequency domain resource; the same frequency hopping configuration; the same cyclic shift; or the same SRS base sequence.

In some implementations, the usage includes at least one of the following: channelPrediction, DLchannelPrediction, ULchannelPrediction, TDCP measurement, or antennaSwitching.

In some implementations, the SRS resources in the multiple SRS resources are aperiodic SRS resources triggered by the same signaling; or the SRS resource sets among the multiple SRS resource sets are aperiodic SRS resource sets triggered by the same signaling.

In some implementations, the same signaling is also used to schedule the PUSCH, and the SRSs on the multiple SRS resources or the multiple SRS resource sets are used to predict the channel state information of the PUSCH; or, the same signaling is also used to schedule the PDSCH, and the SRSs on the multiple SRS resources or the multiple SRS resource sets are used to predict the channel state information of the PDSCH.

In some implementations, the SRS resources in the multiple SRS resources are semi-persistent SRS resources or periodic SRS resources with the same period, or the SRS resource sets in the multiple SRS resource sets are semi-persistent SRS resource sets or periodic SRS resource sets with the same period.

In some implementations, adjacent two SRS resources in the multiple SRS resources are separated by the same number of symbols or the same number of slots in the time domain; or adjacent two SRS resource sets in the multiple SRS resource sets are separated by the same number of symbols or the same number of slots in the time domain.

In some implementations, the number of symbols is configured by the network device, is defined by a protocol, or is pre-configured; or the number of slots is configured by the network device, is defined by the protocol, or is pre-configured.

In some implementations, the sending unit 2101 is further configured to send UE capability information to the network device. The UE capability information indicates a maximum time length in which the terminal device can maintain the phase consistency.

In some implementations, the terminal device does not expect that a duration length corresponding to the multiple SRS resources or the multiple SRS resource sets exceeds the maximum time length in which the terminal device can maintain the phase consistency.

In some implementations, the receiving unit 2102 is configured to receive first indication information sent by the network device, and the first indication information indicates a first time length.

The SRS transmission device further includes a processing unit which is configured to enable the terminal device to maintain, within the first time length, the phase consistency for the SRSs sent on the multiple SRS resources or the multiple SRS resource sets.

In some implementations, the first time length is less than or equal to the maximum time length in which the terminal device can maintain the phase consistency, or in other words, the first time length is less than or equal to the maximum time length in which the phase consistency is maintained reported by the terminal device.

In some implementations, the processing unit is configured to maintain the phase consistency for the SRSs sent on the multiple SRS resources or the multiple SRS resource sets within any time window with the first time length.

In some implementations, the processing unit is configured to maintain the phase consistency for the SRSs sent on the multiple SRS resources or the multiple SRS resource sets within each time window with the first time length starting from a first time domain position. The first time domain position is determined based on a first time domain offset.

In some implementations, the first time domain offset is configured by the network device, is defined by the protocol, or is pre-configured.

Those skilled in the art should understand that the relevant description of the above SRS transmission device in embodiments of the disclosure may be understood by referring to the relevant description of the SRS transmission method in embodiments of the disclosure.

FIG. 22 is a second schematic structural composition diagram of an SRS transmission device provided by an embodiment of the disclosure, which is applied to a network device. As shown in FIG. 22, the SRS transmission device includes a receiving unit 2201.

The receiving unit 2201 is configured to receive SRSs sent by a terminal device on multiple SRS resources or multiple SRS resource sets. The SRSs on the multiple SRS resources or the multiple SRS resource sets adopt a same transmission mode and a same transmission resource, and have phase consistency.

In some implementations, the SRS transmission device further includes a sending unit 2202 which is configured to send first configuration information to the terminal device. The first configuration information is used for configuring the multiple SRS resources or the multiple SRS resource sets. The multiple SRS resources or the multiple SRS resource sets are configured with the same transmission mode, the same transmission resource, and the same usage.

In some implementations, the same transmission mode includes at least one of the following: the same transmit power; the same power control parameter; the same spatial related parameter; the same number of antenna ports; or the same antenna port.

In some implementations, the same transmission resource includes at least one of the following: the same symbol index; the same frequency domain resource; the same frequency hopping configuration; the same cyclic shift; or the same SRS base sequence.

In some implementations, the usage includes at least one of the following: channelPrediction, DLchannelPrediction, ULchannelPrediction, time domain channel property TDCP measurement, or antennaSwitching.

In some implementations, the SRS resources in the multiple SRS resources are aperiodic SRS resources triggered by the same signaling; or the SRS resource sets in the multiple SRS resource sets are aperiodic SRS resource sets triggered by the same signaling.

In some implementations, the same signaling is also used to schedule the PUSCH, and the SRSs on the multiple SRS resources or the multiple SRS resource sets are used to predict the channel state information of the PUSCH; or the same signaling is also used to schedule the PDSCH, and the SRSs on the multiple SRS resources or the multiple SRS resource sets are used to predict the channel state information of the PDSCH.

In some implementations, the SRS resources in the multiple SRS resources are semi-persistent SRS resources or periodic SRS resources with the same period, or the SRS resource sets among the multiple SRS resource sets are semi-persistent SRS resource sets or periodic SRS resource sets with the same period.

In some implementations, adjacent two SRS resources among the multiple SRS resources are separated by the same number of symbols or the same number of slots in the time domain; or adjacent two SRS resource sets in the multiple SRS resource sets are separated by the same number of symbols or the same number of slots in the time domain.

In some implementations, the number of symbols is configured by the network device, is defined by a protocol, or is pre-configured; or the number of slots is configured by the network device, is defined by the protocol, or is pre-configured.

In some implementations, the receiving unit 2201 is further configured to receive UE capability information sent by the terminal device. The UE capability information indicates a maximum time length in which the terminal device can maintain the phase consistency.

In some implementations, the sending unit 2202 is further configured to send first indication information to the terminal device. The first indication information indicates a first time length, which is a time length in which the terminal device is required to maintain the phase consistency or a time length in which the network device measures the SRSs.

In some implementations, the first time length is less than or equal to the maximum time length in which the terminal device can maintain the phase consistency, or in other words, the first time length is less than or equal to the maximum time length in which the phase consistency is maintained reported by the terminal device.

In some implementations, the SRS transmission device further includes a processing unit, which is configured to perform at least one of uplink channel state information prediction, downlink channel state information prediction, or TDCP measurement based on received SRSs.

Those skilled in the art should understand that the relevant description of the above SRS transmission device in the embodiments of the disclosure may be understood by referring to the relevant description of the SRS transmission method in the embodiments of the disclosure.

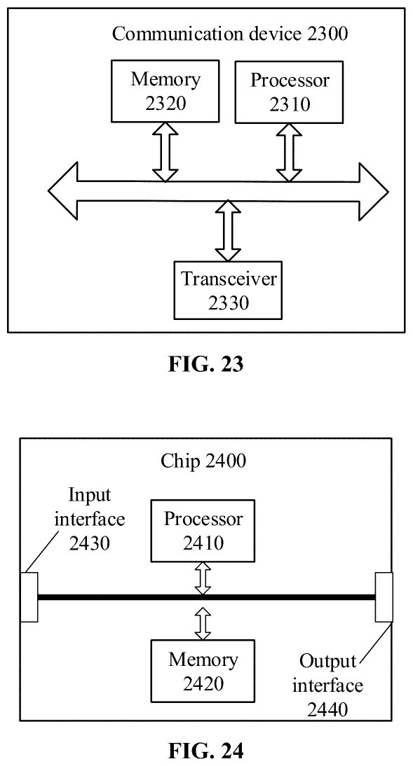

FIG. 23 is a schematic structural diagram of a communication device 2300 provided by an embodiment of the disclosure. The communication device may be a terminal device or a network device. The communication device 2300 as illustrated in FIG. 23 includes a processor 2310. The processor 2310 may invoke and run a computer program from a memory to implement the method according to the embodiments of the disclosure.

In an example, as illustrated in FIG. 23, the communication device 2300 may further include a memory 2320. Herein, the processor 2310 may invoke and run a computer program from the memory 2320 to implement the method in the embodiments of the disclosure.

Herein, the memory 2320 may be a separate component independent of the processor 2310 or may be integrated in the processor 2310.

In an example, as illustrated in FIG. 23, the communication device 2300 may further include a transceiver 2330. The processor 2310 may control the transceiver 2330 to communicate with other devices, in particular, to send information or data to other devices or receive information or data sent from other devices.

Herein, the transceiver 2330 may include a transmitter and a receiver. The transceiver 2330 may further include antennas, the number of which may be one or more.

In an example, the communication device 2300 may be the network device in the embodiments of the disclosure, and the communication device 2300 may implement the corresponding flows implemented by the network device in various methods of the embodiments of the disclosure, and will not be repeated here for the sake of brevity.

In an example, the communication device 2300 may be the mobile terminal/terminal device in the embodiments of the disclosure, and the communication device 2300 may implement the corresponding flows implemented by the mobile terminal/terminal device in various methods of the embodiments of the disclosure, and will not be repeated here for the sake of brevity.

FIG. 24 is a schematic structural diagram of a chip of an embodiment of the disclosure. The chip 2400 as illustrated in FIG. 24 includes a processor 2410, and the processor 2410 may invoke and run a computer program from a memory to implement the method in the embodiments of the disclosure.

In an example, as shown in FIG. 24, the chip 2400 may further include a memory 2420. Herein, the processor 2410 may invoke and run a computer program from the memory 2420 to implement the method in the embodiments of the disclosure.

Herein, the memory 2420 may be a separate component independent of the processor 2410 or may be integrated in the processor 2410.

In an example, the chip 2400 may further include an input interface 2430. Herein, the processor 2410 may control the input interface 2430 to communicate with other devices or chips, and in particular, may acquire information or data sent from other devices or chips.

In an example, the chip 2400 may further include an output interface 2440. Herein, the processor 2410 may control the output interface 2440 to communicate with other devices or chips, and in particular, may output information or data to other devices or chips.

In an example, the chip may be applied on the network device in the embodiments of the disclosure, and the chip may implement corresponding processes implemented by the network device in various methods of the embodiments of the disclosure, which will not be repeated here for the sake of brevity.

In an example, the chip may be applied on the mobile terminal/terminal device in the embodiments of the disclosure, and the chip may implement corresponding processes implemented by the mobile terminal/terminal device in various methods of the embodiments of the disclosure, which will not be repeated here for the sake of brevity.

It should be understood that the chip in the embodiments of the disclosure may also be referred to as a system level chip, a system chip, a chip system, a system-on-chip or the like.

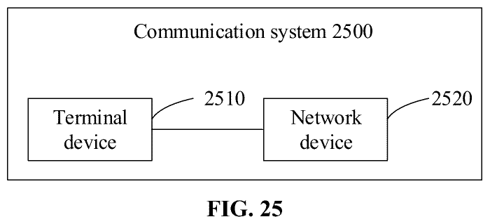

FIG. 25 is a schematic block diagram of a communication system 2500 provided by an embodiment of the disclosure. As shown in FIG. 25, the communication system 2500 includes a terminal device 2510 and a network device 2520.

Herein, the terminal device 2510 may be used to implement the corresponding functions implemented by the terminal device in the above method, and the network device 2520 may be used to implement the corresponding functions implemented by the network device in the above method, and will not be repeated herein for the sake of brevity.

It should be understood that the processor in the embodiments of the disclosure may be an integrated circuit chip, and has the capability of signal processing. During implementation, the various steps of the above method embodiment may be completed by an integrated logic circuit in hardware in a processor or instructions in software form. The above processor may be a general-purpose processor, a digital signal processor (DSP), an application specific integrated circuit (ASIC), a field programmable gate array (FPGA), or another programmable logic device, a discrete gate or a transistor logic device, or a discrete hardware component. The various methods, steps and logic diagrams disclosed in embodiments of the disclosure may be implemented or performed. The general-purpose processor may be a microprocessor or the processor may also be any conventional processor and the like. The steps of the method disclosed in combination with embodiments of the disclosure may be directly embodied to be performed by a hardware decoding processor or a combination of the hardware and software modules in the decoding processor. The software module may be located in a mature storage medium in the art such as a random access memory (RAM), a flash memory, a read-only memory (ROM), a programmable ROM (PROM), an electrically erasable programmable memory, or a register. The storage medium is in a memory, and a processor reads information from the memory to implement steps of the above methods in combination with the hardware.

It can be understood that the memory in embodiments of the disclosure may be volatile memory or non-volatile memory or may include both volatile and non-volatile memory. Here, the non-volatile memory may be a ROM, a PROM, an erasable PROM (EPROM), an electrically EPROM (EEPROM), or a flash memory. The volatile memory may be a RAM that is used as an external cache. By way of example, but not limiting description, RAMs in many forms are available, for example, a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM). It should be noted that, the memory in the system and method described herein is intended to include but not limited to these memories and memories of any other suitable types.

It should be understood that the memory described above is exemplary, but not limiting. For example, the memory in embodiments of the disclosure may also be an SRAM, a DRAM, an SDRAM, a DDR SDRAM, an ESDRAM, an SLDRAM, and a DR RAM, etc. That is to say, the memory in embodiments of the disclosure is intended to include but not limited to these memories and memories of any other suitable types.

The embodiments of the disclosure further provide a computer-readable storage medium for storing a computer program.

In an example, the computer-readable storage medium may be applied to the network device in the embodiments of the disclosure, and the computer program causes a computer to perform corresponding flows implemented by the network device in various methods of embodiments of the disclosure, and will not repeated herein for simplicity.

In an example, the computer-readable storage medium may be applied to the mobile terminal/terminal device in the embodiments of the disclosure, and the computer program causes the computer to perform the corresponding flows implemented by the mobile terminal/terminal device in various methods of the embodiments of the disclosure, and will not repeated herein for simplicity.

The embodiments of the disclosure further provide a computer program product, which includes computer program instructions.

In an example, the computer program product may be applied to the network device in the embodiments of the disclosure, and the computer program instructions cause the computer to perform the corresponding flows implemented by the network device in various methods of the embodiments of the disclosure, and will not be repeated herein for simplicity.

In an example, the computer program product may be applied to the mobile terminal/terminal device in the embodiments of the disclosure, and the computer program instructions cause the computer to perform the corresponding flows implemented by the mobile terminal/terminal device in various methods of the embodiments of the disclosure, and will not be repeated herein for simplicity.

The embodiments of the disclosure further provide a computer program.

In an example, the computer program may be applied to the network device in embodiments of the disclosure, and when running on the computer, the computer program causes the computer to perform the corresponding flows implemented by the network device in various methods of the embodiments of the disclosure, and will not be repeated herein for simplicity.

In an example, the computer program may be applied to the mobile terminal/terminal device in the embodiments of the disclosure, and when running on the computer, the computer program causes the computer to perform the corresponding flows implemented by the mobile terminal/terminal device in various methods of the embodiments of the disclosure, and will not repeatedly herein for simplicity.

Those skilled in the art will appreciate that the various example units and algorithm steps described in conjunction with the embodiments disclosed in the disclosure can be implemented in electronic hardware or a combination of computer software and electronic hardware. Whether these functions are performed in hardware or software depends on the specific application and design constraints of the technical solution. Those skilled in the art may use different methods for each particular application to implement the described function, but such implementation should not be considered beyond the scope of the present application.

Those skilled in the art will clearly appreciate that, for convenience and brevity of description, the specific operating processes of the above-described systems, apparatuses and units may not be repeated herein with reference to the corresponding processes in the aforementioned method embodiments.

In several embodiments provided by the disclosure, it should be understood that the disclosed systems, apparatuses and methods may be implemented in other ways. For example, the above-described apparatus embodiments are only exemplary. For example, the partition of units is only a logical functional partition, which may be implemented in another way, for example, multiple units or components may be combined or integrated into another system, or some features may be ignored or not performed. On the other hand, the coupling, direct coupling or communication connection between each other shown or discussed above may be indirect coupling or communication connection through some interfaces, devices or units, and may be electrical, mechanical or other form.

The units illustrated as separate components may or may not be physically separated, and components displayed as units may or may not be physical units, i.e. may be located in one place, or may be distributed over multiple network units. Some or all of the units may be selected according to actual needs to achieve the object of embodiments of the disclosure.

In addition, the functional units in each embodiment of the disclosure may be integrated in one processing unit, each unit may exist physically alone, or two or more units may be integrated in one unit.

The functions may be stored in a computer readable storage medium if implemented in the form of software functional units and sold or used as independent products. Based on such understanding, the technical solution of the disclosure in essence, or a part contributing to the prior art, or a part of the technical solution, may be embodied in the form of a software product. The computer program product is stored in a storage medium and includes several instructions for causing a computer device (which may be a personal computer, a server, or a network device, etc.) to perform all or part of the steps of the method of respective embodiments of the disclosure. The aforementioned storage medium includes various mediums capable of storing program codes such as a U disk, a mobile hard disk, an ROM, an RAM, a magnetic disk or an optical disk.

The forgoing is only the specific implementation of the disclosure, but the scope of protection of the disclosure is not limited thereto. Any changes or substitutions which can be easily conceived by those skilled in the art within the technical scope disclosed in the disclosure who are familiar with the technical field should be covered within the scope of protection of the disclosure. Therefore, the scope of protection of the disclosure shall be subject to the scope of protection of the claims.

1. A sounding reference signal (SRS) transmission method, comprising:
sending, by a terminal device, SRSs on a plurality of SRS resources or a plurality of SRS resource sets, wherein the SRSs on the plurality of SRS resources or the plurality of SRS resource sets adopt a same transmission mode and a same transmission resource, and have phase consistency.

2. The method of claim 1, further comprising:
receiving, by the terminal device, first configuration information sent by a network device, wherein the first configuration information is used for configuring the plurality of SRS resources or the plurality of SRS resource sets, and the plurality of SRS resources or the plurality of SRS resource sets are configured with the same transmission mode, the same transmission resource, and a same usage.

3. The method of claim 1, wherein the same transmission mode comprises at least one of the following:
a same transmit power;
a same power control parameter;
a same spatial related parameter;
a same number of antenna ports; or
a same antenna port, and/or
wherein the same transmission resource comprises at least one of the following:
a same symbol index;
a same frequency domain resource;
a same frequency hopping configuration;
a same cyclic shift; or
a same SRS base sequence.

4. The method of claim 2, wherein the usage comprises at least one of the following: channel prediction, downlink channel prediction, uplink channel prediction, time domain channel property (TDCP) measurement, or antenna switching.

5. The method of claim 1, wherein
SRS resources in the plurality of SRS resources are aperiodic SRS resources triggered by a same signaling; or
SRS resource sets in the plurality of SRS resource sets are aperiodic SRS resource sets triggered by a same signaling.

6. The method of claim 5, wherein
the same signaling is also used for scheduling a physical uplink shared channel (PUSCH), and the SRSs on the plurality of SRS resources or the plurality of SRS resource sets are used for predicting channel state information of the PUSCH; or
the same signaling is also used for scheduling a physical downlink shared channel (PDSCH), and the SRSs on the plurality of SRS resources or the plurality of SRS resource sets are used for predicting channel state information of the PDSCH.

7. The method of claim 1, wherein
adjacent two SRS resources in the plurality of SRS resources are separated by a same number of symbols or a same number of slots in a time domain; or,
adjacent two SRS resource sets in the plurality of SRS resource sets are separated by a same number of symbols or a same number of slots in the time domain,
wherein
the number of symbols is configured by a network device, is defined by a protocol, or is pre-configured; or,
the number of slots is configured by the network device, is defined by the protocol, or is pre-configured.

8. The method of claim 1, further comprising:
sending, by the terminal device, UE capability information to a network device, the UE capability information indicating a maximum time length in which the terminal device is able to maintain the phase consistency.

9. The method of claim 1, further comprising:
not expecting, by the terminal device, that a duration length corresponding to the plurality of SRS resources or the plurality of SRS resource sets exceeds a maximum time length in which the terminal device is able to maintain the phase consistency.

10. The method of claim 1, further comprising:
receiving, by the terminal device, first indication information sent by a network device, wherein the first indication information indicates a first time length; and
maintaining, by the terminal device within the first time length, the phase consistency for the SRSs sent on the plurality of SRS resources or the plurality of SRS resource sets,
wherein the first time length is less than or equal to a maximum time length, reported by the terminal device, in which the terminal device is able to maintain the phase consistency.

11. The method of claim 10, wherein the maintaining, by the terminal device within the first time length, the phase consistency for the SRSs sent on the plurality of SRS resources or the plurality of SRS resource sets comprises:
maintaining, by the terminal device within any time window with the first time length, the phase consistency for the SRSs sent on the plurality of SRS resources or the plurality of SRS resource sets; or
maintaining, by the terminal device within each time window with the first time length starting from a first time domain position, the phase consistency for the SRSs sent on the plurality of SRS resources or the plurality of SRS resource sets, wherein the first time domain position is determined based on a first time domain offset.

12. A sounding reference signal (SRS) transmission method, comprising:
receiving, by a network device, SRSs sent by a terminal device on a plurality of SRS resources or a plurality of SRS resource sets, wherein the SRSs on the plurality of SRS resources or the plurality of SRS resource sets adopt a same transmission mode and a same transmission resource, and have phase consistency.

13. The method of claim 12, further comprising:
sending, by the network device, first configuration information to a terminal device, wherein the first configuration information is used for configuring the plurality of SRS resources or the plurality of SRS resource sets, and the plurality of SRS resources or the plurality of SRS resource sets are configured with the same transmission mode, the same transmission resource, and a same usage.

14. The method of claim 12, wherein the same transmission mode comprises at least one of the following:
a same transmit power;
a same power control parameter;
a same spatial related parameter;
a same number of antenna ports; or
a same antenna port, and/or
wherein the same transmission resource comprises at least one of the following:
a same symbol index;
a same frequency domain resource;
a same frequency hopping configuration;
a same cyclic shift; or
a same SRS base sequence.

15. The method of claim 13, wherein the usage comprises at least one of the following: channel prediction, downlink channel prediction, uplink channel prediction, time domain channel property (TDCP) measurement, or antenna switching.

16. The method of claim 12, wherein
adjacent two SRS resources in the plurality of SRS resources are separated by a same number of symbols or a same number of slots in a time domain; or,
adjacent two SRS resource sets in the plurality of SRS resource sets are separated by the same number of symbols or a same number of slots in the time domain,
wherein
the number of symbols is configured by the network device, is defined by a protocol, or is pre-configured; or,
the number of slots is configured by the network device, is defined by the protocol, or is pre-configured.

17. The method of claim 12, further comprising:
receiving, by the network device, UE capability information sent by the terminal device, wherein the UE capability information indicates a maximum time length in which the terminal device is able to maintain the phase consistency.

18. The method of claim 12, further comprising:
sending, by the network device, first indication information to the terminal device, wherein the first indication information indicates a first time length, and the first time length is a time length in which the terminal device is required to maintain the phase consistency or a time length in which the network device measures the SRSs,
wherein the first time length is less than or equal to a maximum time length, reported by the terminal device, in which the terminal device maintains the phase consistency.

19. The method of claim 12, further comprising:
performing, by the network device based on received SRSs, at least one of the following operations: uplink channel state information prediction, downlink channel state information prediction, or TDCP measurement.

20. A terminal device comprising a processor, a transceiver and a memory, wherein the memory is configured to store a computer program, and the processor is configured to invoke and run the computer program stored in the memory to control the transceiver to send SRSs on a plurality of SRS resources or a plurality of SRS resource sets, wherein the SRSs on the plurality of SRS resources or the plurality of SRS resource sets adopt a same transmission mode and a same transmission resource, and have phase consistency.
